(19) United States
(12) Patent Application Publication
(10) Pub. No.: US 2025/0147995 A1
(43) Pub. Date: May 8, 2025

(54) Non-linear Writing Software

(71) Applicant: Qiyue Zhang, Bangkok (TH)

(72) Inventor: Qiyue Zhang, Bangkok (TH)

(21) Appl. No.: 18/208,274

(22) Filed: Nov. 6, 2023

(51) Int. Cl. G06F 16/34

(52) U.S. Cl. CPC G06F 16/34

(57) ABSTRACT

In the age of generative AI, it is more important than ever to booster human writing skills so that human writers stay in the driver seat of their own story-telling. This disclosure aims to reduce creative friction in the writing process and enable everyday writers to create works of authorship with ease and delight by a computerized method and system with suitable and specific data-structuring and presentation of user's input contents, encouraging users to input fragmented information utilizing fragmented time without losing coherence, and write in a non-traditional and non-linear way.

### BRIEF DESCRIPTION OF DRAWINGS

1. Example Object Graph For Database

2A. Graphic Presentation mode

2B. Text Presentation Mode

3. Examples Of Variations Of The 2 Basic Modes

4. An Illustration Of An Example Of Snippet Structure With Child-To Relationships Omitted

5A. Illustration One of Two Possible Different Snippet Structures Consisting Of Same Snippets, With Difference Of Structures Due To Different Orders Of Children

5B. Illustration Two of Two Possible Different Snippet Structures Consisting Of Same Snippets, With Difference Of Structures Due To Different Orders Of Children

6. A Simplified Tree View With Treelets For “Root” And “Branch-Leaf” Snippet Types

7. Illustration Of A Sequence With Four Snippets, With Arrows Indication The Direction Of Order

8. Simplified Tree View With Various Elements

9A. Zoom Frame Illustrations Of Tree View: Zoomed Out Most

9B. Zoom Frame Illustrations Of Tree View: Zoomed in

9C. Zoom Frame Illustrations Of Tree View: Zoomed in Further

9D. Zoom Frame Illustrations Of Tree View: Zoomed in the Most

10. A Simplified Example Of Snippet View

11A. Illustrations of Changing Child Treelets Order in Snippet Structure in UI: Position Before Move

11B. Illustrations of Changing Child Treelets Order in Snippet Structure in UI: Position After Move

12A. Snippet Structure Illustration Before The Merge Of Two Snippets #4 and #2

12B. Snippet Structure Illustration After The Merge Of Two Snippets #4 and #2

12C. Sequence Illustration Before The Merge Of Two Snippets #4 and #2

12D. Sequence Illustration After The Merge Of Two Snippets #4 and #2

13A. Snippet Structure Illustration Before The Merge Of A Snippet And A Snippet Structure

13B. Snippet Structure Illustration After The Merge Of A Snippet And A Snippet Structure

13C. Sequence Illustration Before The Merge Of A Snippet And A Snippet Structure

13D. Sequence Illustration After The Merge Of A Snippet And A Snippet Structure

14A. Snippet Structure Illustration Before The Merge Of A Snippet Structure

14B. Snippet Structure Illustration After The Merge Of A Snippet Structure

14C. Sequences Illustration Before The Merge Of A Snippet Structure

14D. Sequences Illustration After The Merge Of A Snippet Structure

15A. Illustration Of Connecting A Treelet To A Ribbon In Tree View: Before Connecting

15B. Illustration Of Connecting A Treelet To A Ribbon In Tree View: After Connecting

16. Illustration Of Using Spread Or Pinch Gesture To Adjust Treelet Length

17. Illustration Of Using Drag And Drop Gesture To Adjust Child Treelet Position On Parent

18. Illustration Of Using Two Fingers In A Twisting Gesture To Adjust The Angle Of An Attached Treelet

19. Illustration Of Before And After Adjusting The Angle Of An Attached Treelet

20. Illustration Of Before And After Adjusting The Angle Of A Trunk Treelet

21. Simplified Text Stream View

22. Simplified View-Only Mode Of Text Stream View Showing Continuous Text

23A. Illustration Of An Example Of Auto-Generating A Sequence Based On “Time Last Edited” Timestamps And Snippet Structures: Snippet Structures with “Time Last Edited” Timestamps

23B. Illustration Of An Example Of Auto-Generating A Sequence Based On “Time Last Edited” Timestamps And Snippet Structures: Sub-sequences with Representing Timestamps

23C. Illustration Of An Example Of Auto-Generating A Sequence Based On “Time Last Edited” Timestamps And Snippet Structures: Finished Sequence

24A. Illustration Of Using Spread Gesture To Create A New Snippet In Text Stream: Before New Snippet Card Added

24B. Illustration Of Using. Spread Gesture To Create A New Snippet In Text Stream: After New Snippet Card Added

25A. Illustration Of Using Spread Gesture To Create A New Snippet In Text Stream: Before New Snippet Card Added

25B. Illustration Of Using Spread Gesture To Create A New Snippet In Text Stream: After New Snippet Card Added

26A. Illustration Of Using Spread Gesture To Create A New Snippet In Text Stream: Before New Snippet Card Added

26B. Illustration Of Using Spread Gesture To Create A New Snippet In Text Stream: After New Snippet Card Added

27A. Illustration Of Before And After Using Drag And Drop Gesture To Shift Snippet Card Order In A Text Stream With Horizontal Arrangements: Before Snippet Card Moved

27B. Illustration Of Before And After Using Drag And Drop Gesture To Shift Snippet Card Order In A Text Stream With Horizontal Arrangements: After Snippet Card Moved

28A. Illustration Of Before And After Using Drag And Drop Gesture To Shift Snippet Card Order In A Text Stream With Horizontal Arrangements: Before Snippet Card Moved

28B. Illustration Of Before And After Using Drag And Drop Gesture To Shift Snippet Card Order In A Text Stream With Horizontal Arrangements: After Snippet Card Moved

29A. Illustration Of Before And After Using Drag And Drop Gesture To Shift Snippet Cards In A Horizontal Arrangement Block In Text Stream: Before Snippet Card Moved

29B. Illustration Of Before And After Using Drag And Drop Gesture To Shift Snippet Cards In A Horizontal Arrangement Block In Text Stream: After Snippet Card Moved

30. Altering Snippets Process Flow Chart

31. Process Flow Chart Of Changing Child Treelets Order

32. Process Flow Chart Of Deleting A Snippet Relationship From Tree View Using The “Cutting Tool” And The Long Press Gesture

33. Process Flow Chart Of Connecting Two Treelets With Snippet Relationships In Tree View

34. Process Flow Chart Of Deleting A Snippet In Tree View

35. Process Flow Chart Of Recycling Snippet

36. Process Flow Chart Of Determining Free-Moving Scope Of Treelet Or Treebranch In Treeview

37. Process Flow Chart Of Merge Operations In Tree View

38. Process Flow Chart Of Splitting A Snippet

39. Process Flow Chart Of Long Press On Ribbon To Change Ribbon Appearance Or Delete Ribbon

40. Process Flow Chart Of Long Press On Treelet To Start A Ribbon On It Or Remove It From Existing Ribbons.

41. Process Flow Chart Of Changing The Length, Angle Or Position Of Treelets, Connecting A Treelet To A Ribbon In Tree View

42. Simplified Process Flow Chart Of An Text Stream Reordering Attempt

43. Process Flow Chart Of Creating A Snippet In Tree View And Text Stream View

44. Process Flow Chart Of Removing A Snippet From A Sequence In Text Stream View And Deleting A Snippet Card In Text Stream View

45. Process Flow Chart Of Dropping A Treelet Into A Main View Of Another Project

46. Process Flow Chart Of Change Appearance Of, Rename Or Delete A Sequence In Text Stream View

47. Process Flow Chart Of Folding A Snippet Card In The Text Stream

48. Process Flow Chart Of Splitting And Recycling Selected Text Out Of A Snippet Card

49. Process Flow Chart Of Switching Text Stream View To Show Another Sequence

50. Profile Views

51. Short Profile Card View

52. Profile Card View

53. Profile Library View

54. Process Flow Chart Of Creating A Superlink To Profile From Snippet View And Snippet Card)

55. Process Flow Chart Of Removing A Superlink To Profile From Snippet View, Snippet Card

56. Process Flow Chart Of Creating A Profile In Profile Library View

57. Process Flow Chart Of Deleting A Profile In Profile Library View

58. Recycle Bin View Graphical Mode

59. Recycle Bin View Test-List Mode With Corresponding Snippet Structure

60. Recycle Bin System Views Navigation

61. Process Flow Chart Of Restoring From Recycle Bin View

62. Process Flow Chart Of Delete Recycled Objects In Recycle Bin

63A. A Simplified View Showing Text Being Selected As A First Step To Create A Switch.

63B. A Simplified View Showing A Switch Button Overlapping The Previously Selected Text

63C. A Simplified View Showing A Switch Card View That Appears After The Switch Button Is Tapped.

64. Process Flow Chart Of Switch Creation From Snippet View Or Snippet Card

65. Process Flow Chart Of Adding An Alternative Option To A Switch Button

66. Process Flow Chart Of Deleting Or Editing A Switch Button Alternative Option

67. Process Flow Chart Of Deleting A Switch And All Its Alternative Options Not On Display

68. Process Flow Chart Of Switch To Alternative Text By Swiping

69. Example Element Set For Reward Background

70. Example Snippet View Background For Reward In Progress

71. Example Reward Snippet View Background In Completion

72. Versioning Navigation

73. Process Flow Chart Of Switch To Alternative Text By Tapping

### THE AIM OF THE INVENTION

Ordinary people who are not trained professional writers often think of writing a fictional work or a long essay as a daunting task that requires a tremendous amount of time, dedication and skills. Even many professional writers may get frustrated trying to put what's in one's head onto a page of words, even though they already know what story they want to tell. As a result, there exist huge unrealized creative energy in societies, which if realized can transform how people see writing: instead of a difficult-to-master art form, writing expressively and coherently, even at full length should be accessible to ordinary people to deliberatively express themselves without too much stress. Yet, natural frictions arise when people try to pull a multidimensional, evolving concept from their mind into a linearly presented written work. This disclosure aims to reduce such frictions by introducing a non-linear system of writing that will be installed on easily accessible general computing devices such as but not limited to a smart phone or a personal computer, that enables the user, whether as an amateur or experienced writer, to input, organize, edit, and review their works in ways not restrained by fictional orders such as the story timeline, chapters, logic, plot, or any such orders that need to be followed in the final version of a written work. The APP will do that firstly by providing multiple interrelated ways to input and organize small chunks of information so that even if the inputs are a large amount of fragmented pieces of the entire work put in at no particular order, they will be manageable, organized by and presentable to the user in coherent manners. Then the app will enable the user to transition between different presentations of their work to bridge the gap between how the work exist in their mind and how it should be presented on pages. This system of non-linear writing will also ensure that the writing process is optimized for the user's evolving vision of their work instead of pining it down to less than what it could be if the user writes in the traditional, linear way.

### BACKGROUND

Although there are many writing applications in the market, I have never encountered one that fully address the creative friction problem satisfyingly because the underlying problem remains unsolved. Applications that provide plot outlines, settings or other story elements that instruct or subsidize the creative process do not really address the problem directly and are different in aims from this disclosure. They relieve some burdens of planning and creating from writers but the writers still face the same frustrations with the rest of the writing that is not subsidized or instructed. Creative decisions still have to be made and the work still has to be written, or it wouldn't be the writer's work. In the age of generative AIs, it is easy to generate machine-written text, but that is not what this disclosure is about. If anything, it strikes the importance of the aim of this disclosure to increase human writing fluency, by reducing creative friction.

Sometimes thought-map applications are used for writing. Those apps offer flexibility in constructing the structure of the story. However, often more time and energy are spent on establishing the logical map than on actual writing. Too much freedom in the structuring process leaves the average writers frustrated because they may initially feel at a lost and then constantly have to put a lot of effort in drawing the logical structure instead of actual writing and the result of the thought-map apps looks nothing like a coherent literary work but a massive flowchart.

The most common writing applications are simply variations of a traditional writing pad digitalized, with a file system. There might be added features like file-sharing or distraction-free mode, but those are parallel to the core problem this disclosure aims to solve.

### Definitions

### Non-linear

refers to not being restrained by fictional orders such as the story timeline, chapters, logic, plot, or any such orders that need to be followed in the final version of a written work presented to the readers when in the process of writing it.

### APP

refers to any iteration of the non-linear writing software that is enabled by this disclosure.

### View

refers to a scene, or an instance, of the user interface of the APP.

### Project 103

refers to the data structure of user-established writing project in the APP that owns snippets.

Snippet 105 refers to the data structure of a unit of textual input(s) entered by the user.

### Snippet View 118

refers to the View for individual snippet to be created, viewed and edited by the user.

### Snippet Relationship 121

refers to relationships between snippets. It is the way snippets can be connected to form Snippet Structure. All related snippets must have the same Project and Recycle statuses.

### 8. Snippet Structure 127

refers to a group of snippets that are connected by snippet relationships.

### Snippet Sequence 128

refers to an ordered list of snippets from within one Project.

### Ribbon

refers to the visual representation of Sequence in both Tree View and in Text Stream View.

Tree View 135 refers to the View of preferred graphical presentation of a Project, showing Snippet

Structures in a visual way.

Text Stream View 145 refers to the View that displays the textual contents of a snippet Sequence in its order.

### 13. Profile 160

refers to an unit of structured information entered by the user that is enabled to be linked to from within the APP.

### Profile Library 175

refers to a virtual space where the Profiles are collected.

### Recycle

refers to the action to give a snippet, Snippet Structure, or other types of user inputs units, a “recycled” status.

### Recycle Bin 177

refers to a collection of recycled snippets, Snippet Structures, or other types of user inputs units that are recycled, which are no longer shown in the Project Views due to their “recycled” statuses.

### Data Store

refers to any data persistence structures, such as a database, accessible to and utilized by the APP to store and manipulate the APP's persisted Data.

### Note

It should be noted that all the detailed explanations of the embodiments mentioned below are not meant to be the only possible interpretations and implementations of the APP enabled by this disclosure. They are mainly to show how to make such an APP. For example, in the process flowcharts of the drawings, the order of specific steps can sometimes be exchanged or performed concurrently and not effect the outcome, especially those involving updating the UI and persisting changes to data store. Similarly, whether a button or a menu option is used in UI to initiate an action is not crucial. Further, in the description of preferred embodiments, only one text property is described for the snippet 105 data structure, which is the content 106 of the snippet, but the snippet can also have a title 111 text property in addition to the content property. If a title property is included in the snippet, then it will be possible that when zooming in in the Tree View 135, before the contents of the corresponding snippets are shown on the treelets 136, the titles will be shown first, and the contents will only replace the titles when zoomed in even further, or it is also possible that only the titles are ever shown when zoomed in. Such variations may add or subtract details in implementation, but they do not change the core of what this disclosure is about.

It should also be noted that simply integrating AI into the workflow of the APP, for example to generate texts to “fill in the gaps” between snippets, create new snippets or output entire works based on existing user snippets by any AI language model, does not make a fundamental difference to the workings of the APP.

### Presentation Mode Transition

As mentioned, there exists natural gap between the multi-dimensional and evolving idea of a work in the mind and the linear presentation of it on pages that gives rise to creative friction that hinders aspiring writers. To bridge this gap, this disclosure contains a multi-mode Project presentation structure, enabling APPs that enact at least a 2-step mode-switching. Step 1: a mode 101 to mimic in a symbolized way how creative work exist in the mind, minimizing the friction pulling ideas out from the mind. This is implemented in the preferred embodiment as Tree View 135. Step 2: a mode 102 that resembles how the written work is presented to readers. This is implemented in the preferred embodiment as Text Stream View 150. With a single switch, for example a swipe gesture in a touch device, in the APP, a user can transform their project 103 presentation from first mode 101 to second mode 102, which means from a visual presentation closer to what's in a person's mind to closer to the finished draft. Although called step 1 and 2 here, a user can actually freely jump between the two presentation modes while they write. “Non-linear” in this context takes on a meaning of how user works between these two modes, in addition to how they input and organize their writings.

Please note that there can be variations based on the two base modes. For example, in the Text Presentation section, a view-only mode 155 is discussed. Variations that doesn't change the underlying data structure and logic of this disclosure should not be considered as anything fundamentally different.

### Predefined but Flexible Snippet Structuring

A snippet 105 is a unit of data structure that holds user input texts. It must consist of at least one text field. Those snippets can be connected to each other and form Snippet Structures 127. This disclosure aims to ensure the right balance of flexibility and simplicity of structuring of snippets 105 for efficient usability. Two aspects significantly influence snippets structuring. One aspect is the snippet types 107. A small limited number of types are made possible for a snippet, which must be of at least one type. The other aspect is the relationships 121 connecting snippets. Such relationships can be defined as one-directional or bi-directional in data structure. However, in a preferred embodiment, the relationships are at least operated as bi-directional from the UI point of view. Snippet relationships must also be of a relationship type 122 among a small limited number of types. A group of snippets that are connected by snippet relationships are called a Snippet Structure 127.

A snippet can be very short, a fragment of the whole project, encouraging users to input fragmented information that can be connected together in various ways. Further, it enables smooth migration of snippet that contains user contents among Projects 103, or even in a specifically designed Recycle Bin 177 system. These will be further explained in later sections.

In implementation, a set of rules regarding the snippet types and relationships can be created to instruct how the operations of the snippets structuring should be set up in codes, ensuring the data integrity and overall operability of the data side of the APP.

Rules may vary in different embodiments, but all snippets 105 in a Snippet Structure 127 should always be either of the same Project 103 or all of no Project 103. An example set of rules can be find in a later section.

The user should be able to change the types of the snippets 105 and form or break relationships 121 from the UI to arrange the snippets into different formations referred to as Snippet Structures 127, as long as not breaking the rules ensuring data integrity. More on this will be explained in later sections.

In a basic embodiment that only has one pair of reversive Snippet Relationships 121 that does not allow any loop or cross-net structuring, a snippet can be of three possible types: Leaf 108, Branch 109, and Trunk 110, each indicating but not limiting the level of abstraction of its content that the user will enter. Leaf would indicate the least abstraction while Trunk the most. Further more, There are two types of relationships 121 between snippets: a child-to relationship 123 and a parent-to relationship 124, which are mutually reverse. If one relationship is deleted, its reverse relationship will also be deleted.

The child-to relationship is to-one, and the parent-to is to-many. Combined, they will be referred to as parent-child relationships, which consist of the two reverse relationships. The related snippets can be referred to as parent 126 or child 125 to the other if they has, respectively, a parent-to or child-to relationship to the other. If a snippet is deleted, so are its relationships, but if a relationship is deleted, the snippets it connects won't be deleted.

### FIG. 4

The children snippets 125 are ordered. This order is also part of the basic snippet-structuring. This order can easily be manipulated by the user, like relationships and snippet types.

### FIG. 3

In a further embodiment, a snippet can have a combination type of both Leaf and Branch, aside from the three single types.

In another related embodiment, the types of snippets can also include a Root type 112, which on data side is similar to a Branch, but in Graphical Presentation will be represented by a different visual element and unlike Branch, will “grow downward” from where the Trunk is attached, indicating deeper meaning or intentions of its content. (FIG. 4)

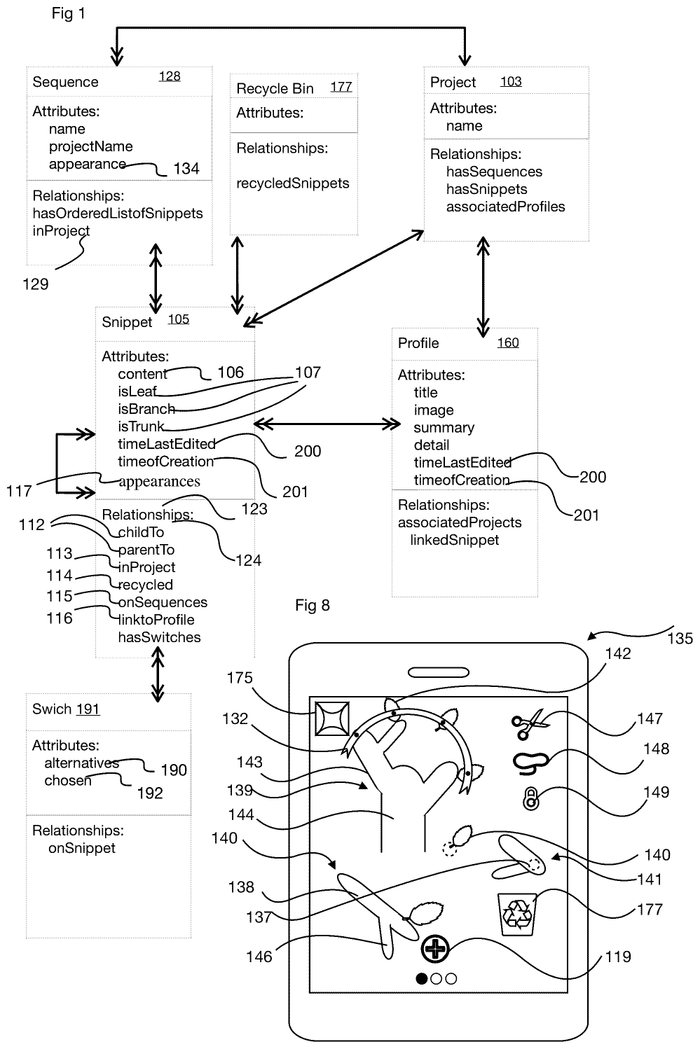

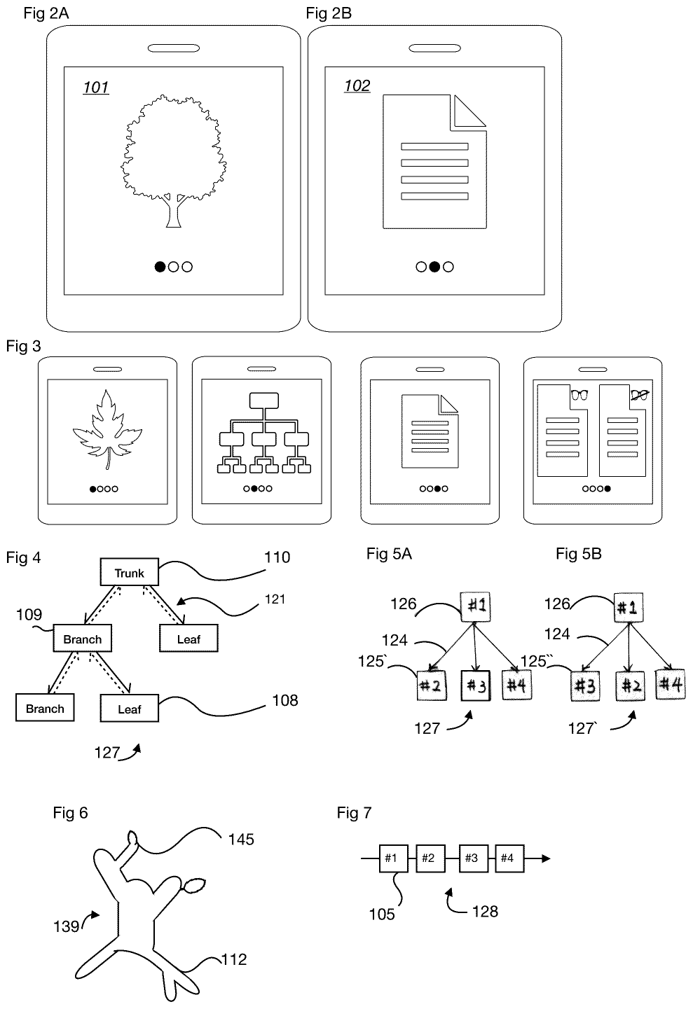

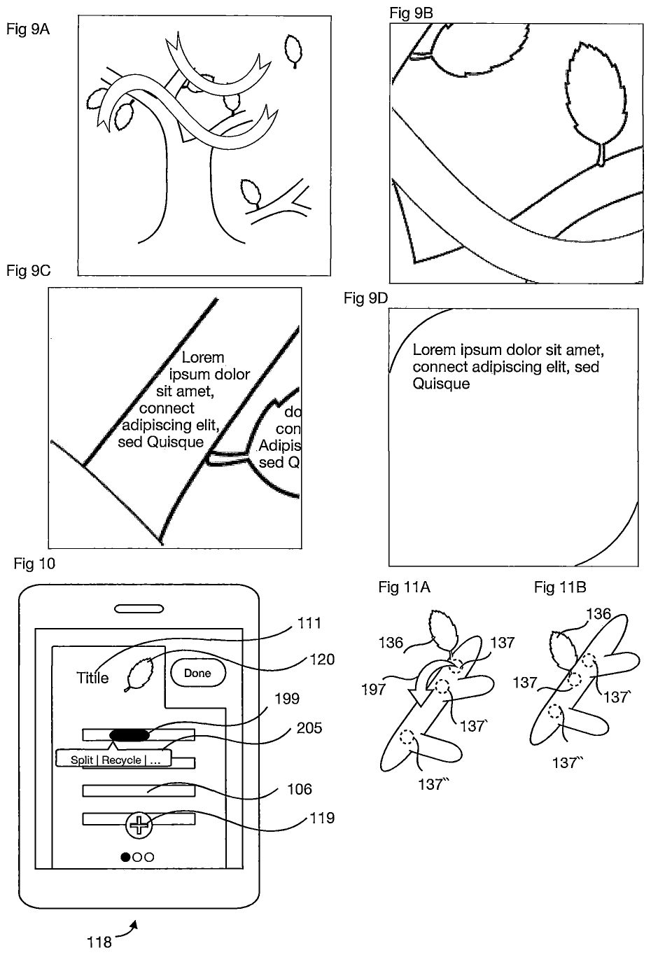

All of the information regarding structuring of the snippets are persisted in data store, preferably through an object-oriented database operation system. Please refers to an example set of rules and a database graph (FIG. 1) of some main features. The snippet 105 and snippet structure 127 both have visual representations shown to the users as explained in the Graphical and Text Presentations sections below.

It is possible to have other types of relationships to add loop or net to the snippet structures in more advanced embodiments. There is a reason tree-like structure, instead of, for instance, parallel circles or nets, is implemented in this basic embodiment. Although ideas or concepts can exist in our mind in any sort of manner, we still live in a reality where time flows forward, and so using tree-like structure without confining everything in one main tree has a grounding effect to the user, because writings still have to make sense to readers in real world, while maintaining flexibility to create parallel structures to some extent. The graphical positioning of the snippets and their structuring in the graphical presentation mode 135 and the addition of another feature, the Sequences 128 also add to the freedom to represent how information and concepts connect and relate in the mind.

### Snippet Sequence

This section is about the data structure of Sequence 128. Its visual representations will be discussed in later sections. Another way to organize snippets 105 that are independent of the Snippets Structures 127 is Sequence 128. A Sequence is an ordered list of snippets of the same Project 103.

FIG. 7 is a simple illustration of a Sequence of four snippets, all in the same Project. The arrow indicates the order of the snippets in this Sequence, not indicating any snippet structure.

Snippets of a Project can be ordered in multiple Sequences that simultaneously exist. Sequences are also persisted in data store and can be altered or updated. The Project a Sequence is associated with can be called its Host Project 129.

Sequences can be auto-generated by the APP in orders based on factors such as but not limited to, time of creation 201 of snippets, time of last edit 200 of snippets, Snippet Structures, or any combination of them.

Sequences can also be user-created in any order the user wants, consisting of a subset or all of the snippets in a Project, chosen by the user.

The order of a user-created Sequence can be altered by the user. It is also possible to add or remove snippets from such a Sequence, delete such a Sequence, and in some embodiments, name and rename such a Sequence. None of those actions will change the snippets themselves, Snippet Structures, or any thing else not directly about the Sequence. However, in some embodiments where altering certain types of auto-generated Sequences is allowed, such altering will be able to change the Snippet Structures. None of these actions are allowed to break the data integrity. For example, all the snippets on the same Sequence must be in the same Host Project 129. The actual implementation and rules of such altering will depend on particular embodiment and will be explained further in the Text Presentation section. (FIG. 7)

### Graphical Presentation: Tree View

A Graphical Presentation mode 101 of Project 103 is offered by the APP. It is considered one of the main Views of a Project 103.

A user Project 103 is presented visually and the structuring 127 of snippets 105 in the Project is shown in such a Graphical Presentation. If Sequence 128 feature is included in an embodiment, the user-created Sequences can also be shown in the Graphical Presentation in a visual way. User should be able to manipulate the Graphical Presentation so that various levels of abstraction or details of the Snippet Structures and Sequences can be dynamically displayed. The user can operate on and make changes to the Snippet Structures and snippets themselves through interacting with the visual elements representing them. If the Sequence feature is included, the user-created Sequences can also be directly altered by its representation in the Graphical Presentation mode. The user may also change the Recycle status 114 of any snippet directly in the Graphical Presentation if the recycling feature is included.

In some embodiments, the user can highlight or choose among different appearances 117 for the visual representations of individual snippets or Snippet Structures. It might include but not limited to: glow effect, color, shape, texture, frame or any combinations of those factors. The highlight or different appearances chosen can also be shown in other Views besides the Graphical Presentation Mode 101, for example, in the Text Presentation Mode 102 and in the individual Snippet View's 118 background.

Snippet View 118 is the View for individual snippet 105 to be created and edited. It can have a snippet type indicator button 120 where user can select the type 107 of the snippet.

In a preferred embodiment on touch devices, a Project's Graphical Presentation is made to resemble a tree, and this presentation is referred to as Tree View 135. In the Tree view, snippets are visually presented to resemble elements of a tree based on their type. For convenience, let's refer to such visual elements as “treelets 136.” Treelet 136 has an attach point 137 on one end that can be used to attach to a parent treelet 136. The attach points cannot overlap once connected. A Leaf type snippet is shown as a leaf-like treelet 142. A Branch type snippet is shown as a twig-like treelet 143. A Trunk type snippet is shown as a trunk-like treelet 144. For a Branch-Leaf combination type snippet, if allowed, its treelet is shown as a twig with a leaf 145. (FIG. 8) The treelets are connected when their corresponding snippets have relationships and are arranged according to the Snippet Structures the snippets are in, as well as user's adjustments to the treelets 143. For convenience, let's refer to such treelet structures as treebranches 141. When viewed as a whole, a treebranch 141 will resemble a natural tree, or a cut-off tree branch.

The order of child treelets 146 on the parent treelet 138 corresponds to the order of children for the corresponding snippets to their parent snippet. For a child snippet, the earlier the snippet is in the order of children, the closer its corresponding treelet's attach point is to the attach point of its parent. However if the parent treelet 138 is currently not child to any treelet, it might not be obvious just by looking at the visual representation to discern which end of the parent has its own attach point, and the look of a stand-alone treebranch by itself might not always make obvious the direction of the order of children.

So it can be said a Snippet Structure 127, including structures only consisting of one snippet, is visually presented as a treebranch 141. Consequently a Project 103 is visually presented as a tree 139 with possibly some stand-alone treebranches 140. The main tree 139 and the independent treebranches 140 (including those containing only one treelet) respectively represent the Snippet Structures 127 connected to the Trunk 110 and those that are not.

In this embodiment, the Tree View can be zoomed in and out to display various levels of overall structures and details of the Project. When zoomed out the most, the overall structure of the Project as a tree is visible, as well as all the stand-alone treebranches. When zoomed in the most, individual snippets' contents can at least be partially seen.

The user-created Sequences are shown as “ribbons” 132 visually, basically long stripes connecting the treelets that represent the snippets on the Sequence 128, in the order of the Sequence. Such a visual presentation of the Sequence is referred to as a Ribbon element 132 in the Tree View. The Ribbon may also have different appearance 134 settings that the user can alter and choose, for example, colors, glows, textures and themes such as holiday, park, forest etc., which will not change the corresponding Sequence but will affect how the Ribbon looks, possibly beyond the Tree View 135. (FIG. 8) (FIG. 9)

In the preferred touch-screen embodiment, the user can perform various actions in the Tree View 135, including but not limited to: to change how the tree 139 and treebranches 141 “look”, to alter the snippets 105, Snippet Structures 127, Sequences 128, and Recycle statuses 114, as well as to move snippets and Snippet Structures to other Projects 103.

1. Altering snippet content 106 and type 107

When zoomed in, it is possible to view at least part of a snippet's content 106 in an enlarged treelet. However, the content is view-only and cannot be altered directly in Tree View. To edit the content of a snippet, the user must navigate from Tree View to the individual Snippet View and make changes from there. This navigation should be straightforward. For example, by a single tap on a treelet, the Snippet View should come up on display showing the corresponding snippet for the user to make changes to. The user can also change snippet type 107 from the individual Snippet View.

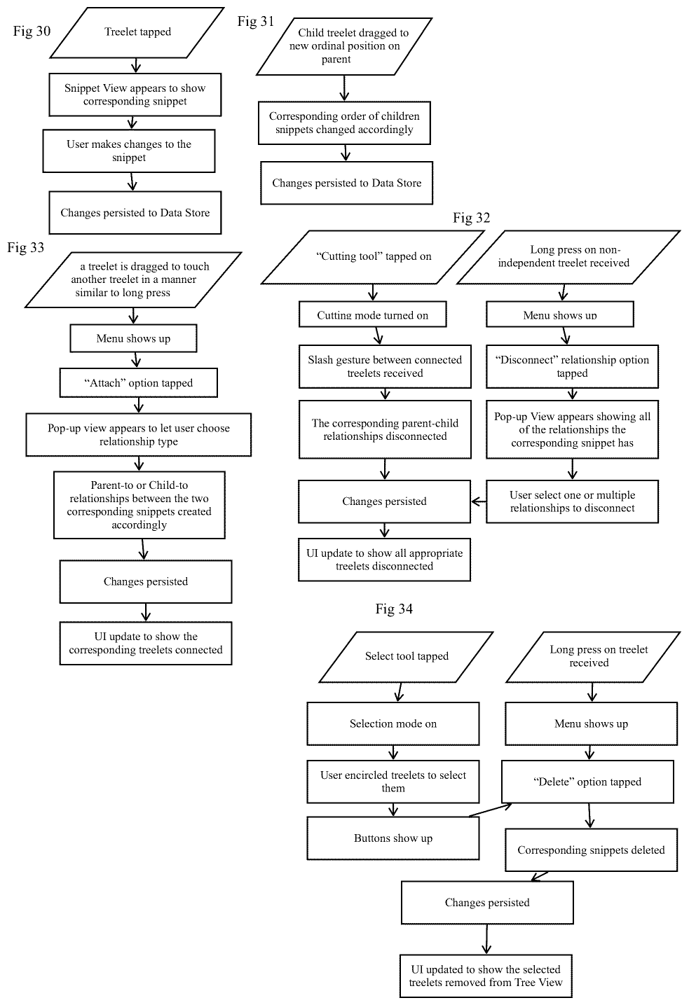

### (FIG. 30) (FIG. 10)

### 2. Moving Treelet 136 or Treebranch 141

In the Tree View, a treelet 136 or treebranch 141 is considered capable of free-moving if it is independent (or cut-off) from any other treelets excluding those of itself in term of snippet relationship 121, and incapable of free-moving if it is attached to another treelet excluding those of itself. So a part of an independent treebranch 140 is not capable of free moving, while the independent treebranch 140 as a whole is. In the preferred embodiment, an exception is that anything attached to the Trunk treelet 144 is not independent, cut-off or free-moving.

Within the Project, user should be able to freely drag and drop any independent (or cut-off) treelet or treebranch 140 to anywhere in the View (except for possibly spaces occupied by unmovable buttons, icons, or other such visual elements). User can also drag and drop a free-moving treelet or treebranch into another Project's main Views or the Recycle Bin Views 179 or onto the Recycle Bin element 178 to change the Project and Recycle statuses 113,114 of the corresponding snippets. Once Project or Recycle statuses are changed, the Sequence memberships 115 of all involved treelets will be deleted.

For a treelet or treebranch attached to a parent 138, it is only possible to move along the parent treelet 138 when only the drag and drop gesture is used. Such movement can potentially change child snippets 125 order, but can not be used to disconnect relationships 121. It is also not possible to do actions requiring free-moving on such an attached treelet or treebranch, such as but not limited to: drag and drop to locations in the Tree View unbound to the parent treelet, to different Views, onto the Recycle Bin element 178 or to merge or connect to another treelet.

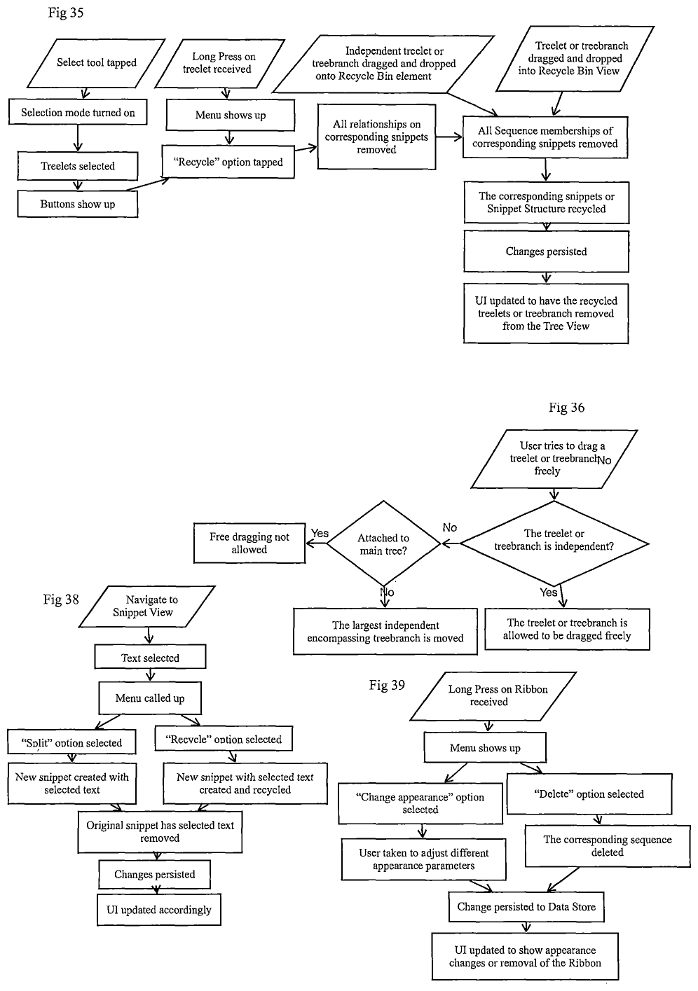

### (FIG. 35)

### 3. Manipulating Snippet Structures: Snippet Relationships 121, Order of Children

### (1) The User Can Change Order of Children

The user can change order of children 125 of the same parent snippet 126 by dragging corresponding child treelets 146 individually so that its attach point moves along the parent treelet 138, to the desired ordinal position among the attach points 137 of other child treelets 146 attached to the same parent. The child treelets order on the parent treelet corresponds to the order of the represented child snippets 146. When the child treelets' order is changed, the underlying child snippets order will also be changed accordingly. (FIG. 900) (FIG. 1000)

### (2) The User Can “Cut Off” a Snippet Relationship 121 by Disconnecting Attached Treelets

To directly delete a relationship 121 in the Tree View, there are two ways in this embodiment. The first is to use a “cutting tool” button 147. When it is tapped “on”, the user can use a finger to slash on screen between two treelets to disconnect them. The corresponding parent-child relationships 121 are deleted. When tapped again, the “cutting tool” 147 turns off, and the user can no longer use the slash gesture to cut off relationships. The second way is to long press on an attached treelet, calling up a menu, where the user can choose to disconnect a relationship or a type of relationships. For example, all the parent-to relationships 124 of a snippet can be deleted at once. (FIG. 32)

### (3) The User Can Establish Relationships 121 Between Snippets 105 by Connecting Treelets 136

In this touch-screen embodiment, the user can use a gesture called “long touch” to connect treelets: dragging one treelet 136 to touch another treelet 136′ for a prolonged period of time similar to long press, then menu will show up for user to select the type of relationship 122 they want. Corresponding snippets will be connected by that relationship and reverse relationship will also be automatically created. (FIG. 33)

### 4. The User Can Create New Snippets 105

One way for user to create a new snippet in the Tree View is to use the “new snippet” button 119 that is present on the main Views of Project. Another way is to long press in the Tree View 135 anywhere empty of visual elements until a menu shows up and select the “new snippet” option. Both will lead to an empty Snippet View to show up where user can input the content 106 and choose types 107. When the Snippet View is dismissed, if it is not empty, the new snippet 105 will be saved in data store and a new corresponding treelet will appear at the point of the long press. In this embodiment, the new snippet if not chosen by user otherwise, will be of the Leaf type 108.

In some embodiments, an option to launch the APP with a new Snippet View 118 is offered in the APP, and can be enabled or disabled by the user. If enabled, the first screen each time the APP is launched will be an empty Snippet View 118. Once the Snippet View is dismissed, the screen goes back to the most recently visited View, which could be the Tree View of the last visited Project, and a new corresponding treelet 136 will appear. The new snippet is saved to the last visited Project 103 if the Snippet View's content is not empty. If no Project currently exists, a new Project 103′ will be automatically created to host the new snippet.

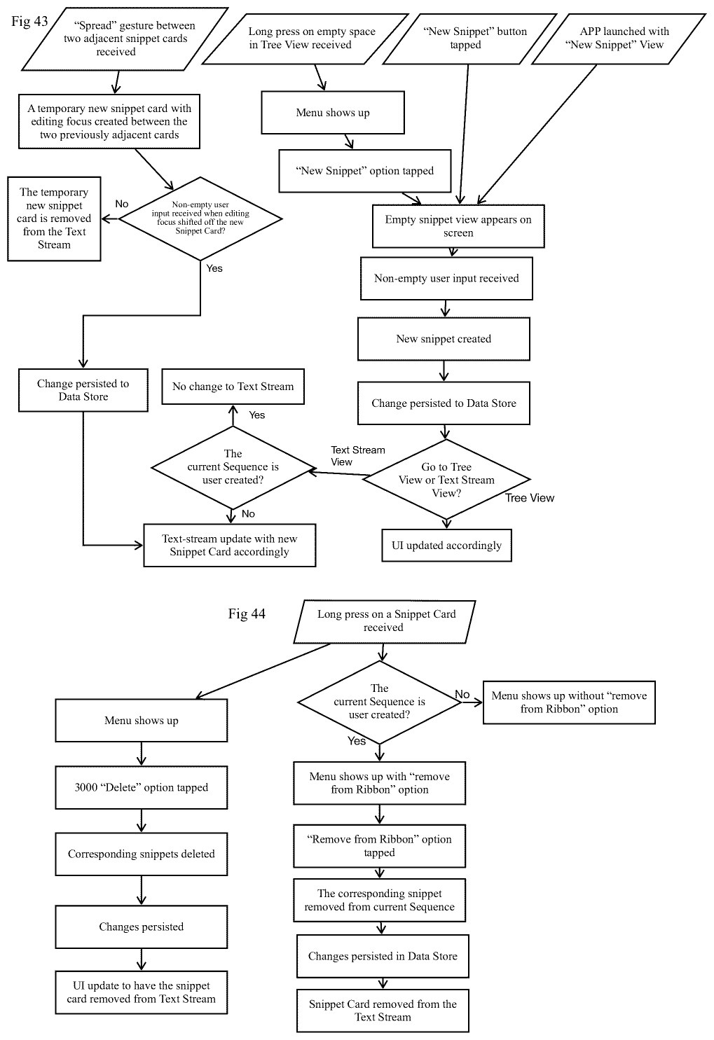

### (FIG. 43)

### 5. The User Can Delete Snippets 105 and Snippet Structures 127

If user wants to delete a snippet 105, they can long press on the corresponding treelet 136, which will call up a menu with option to delete it. Another way is to use the “select tool” 148 to select treelets 136 by drawing a line around the target treelets to encircle them. After the encirclement, the encircled treelets will be selected and a delete button will show up. If the delete button is tapped, the selected treelets will be removed, and their corresponding snippets 105 will be deleted. Relationships 121 and Sequences memberships 115 are deleted with the deleted snippets.

### (FIG. 34)

6. The user Can Recycle Snippets and Snippet Structures

User can also recycle snippets and independent (or cut-off) Snippet Structures into the recycle bin 177.

One way is to recycle single or multiple snippets by long pressing on the corresponding treelet or using the “select tool” 148 in a similar manner to deletion. All recycled snippets will be automatically cut off before entering the recycle bin 177.

Another way to recycle is to drag and drop the target onto a visual element present in the Tree View that represent the Recycle Bin. When a free-to-move treelet or treebranch 140 representing an independent snippet or Snippet Structure is dropped onto the Recycle Bin element 178, the snippet or Snippet Structure become recycled.

Another way is to drag and drop them directly into the Recycle Bin View 179.

Yet another way to recycle is to directly recycle selected text 199 from snippet content 106 from the Snippet View 118. When calling up a menu 205 on the selected text, the user can choose the “recycle” option. Then a new snippet 105 is split out of the original with the selected text as content and put into the Recycle Bin 177.

### (FIG. 35) (FIG. 10)

### 7. Merging Snippets

The user can choose to merge two snippets, a Snippet Structure, or a Snippet Structure and a snippet, into one single snippet. How they are merged will depend both on user actions on the corresponding treelets or treebranch and the structuring of the relevant snippets.

It is important to determine which snippet is the target snippet that will eventually host the composite content after merge. The final snippet type will defer to that of the target snippet. The target snippet's content should be at the beginning of the merged content.

If possible, all Sequence 128 memberships of the merged snippets and the snippets relationships at edge points of a merging Snippet Structure should be preserved, but if not possible, only the target snippet will have its relationships and Sequence memberships preserved. For example, for a Sequence whose members are being merged, if the target snippet is among those merged members, only the membership on the target snippet is preserved; if not, only the membership of the earliest merged member of the Sequence will be preserved. For different

Sequences whose members are simultaneously being merged, they do not interfere with each other and each's memberships are maintained according to the way just mentioned.

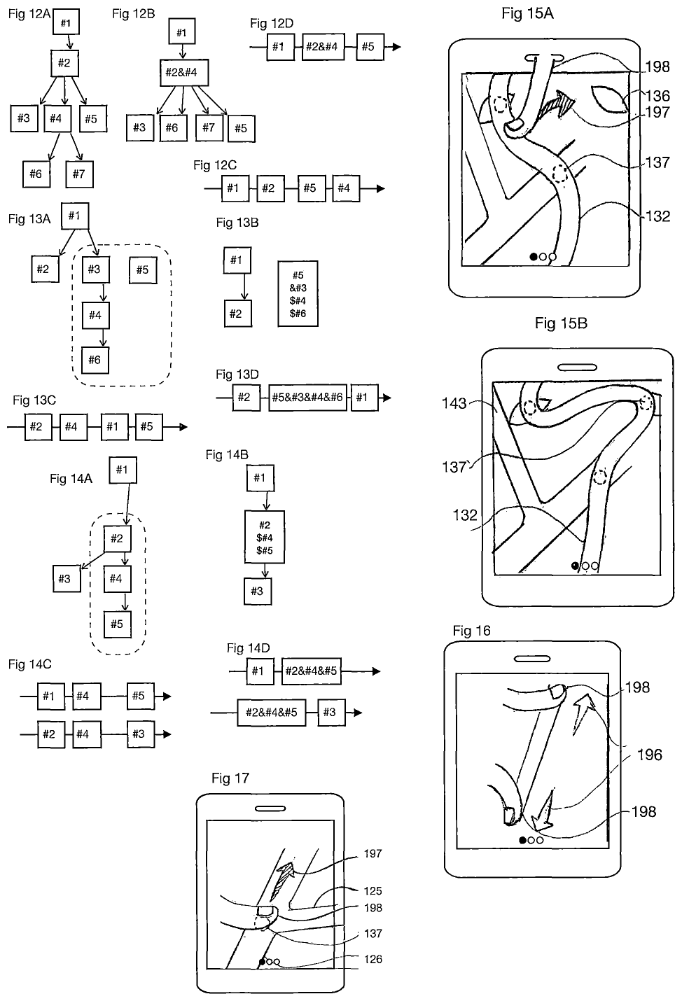

### (FIG. 12) (FIG. 13) (FIG. 14)

Firstly, drag and drop gesture can be used to merge a treelet or treebranch into another treelet, which will represent the target snippet. The Snippet Structure will be merged into itself first before the resulting intermediary-merged snippet is merged into the target snippet.

Secondly, a Snippet Structure can be merged into itself. It can be achieved by using the “select tool” 148 to select it and choose the “merge” option after buttons appear. The highest level parent of the Snippet Structure would be the target snippet.

The Snippet Structure is merged in a Depth-First Traverse manner. Substructures are merged before parent structures, and the order of children is respected. The composite content will have parent level content come before child level content, except for when substructures are involved which need to be merged first. Having the pre-merge structure shown through formatting of the composite content is also a possibility in implementation of the merge. Thirdly, if a treebranch and a treelet not on that treebranch is selected to merge, it will follow the same process as dragging the treebranch into the treelet. Other than that, the merge action will be dismissed if there are multiple treelets not on the same treebranch in the selection.

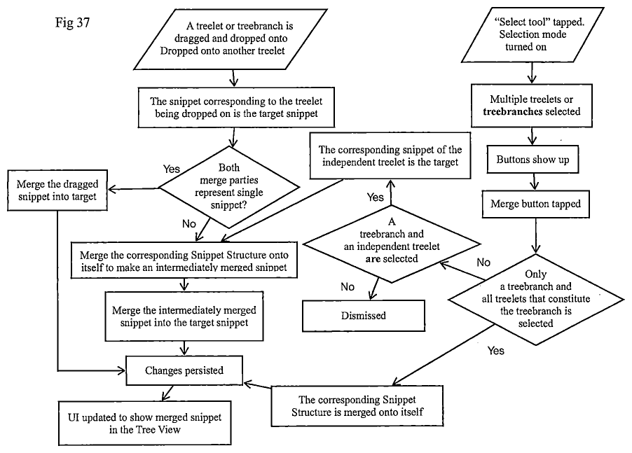

### (FIG. 37)

### 8. Splitting a Snippet

. The user can also split a new snippet out of an existing one, although it is preferred to not be done directly in the Tree View, but in the Snippet View that can be navigated to from the Tree View. Generally, splitting a snippet is possible wherever the content of a snippet can be edited. (FIG. 38)

Snippets are usually split by selecting some text from a snippet's content and use menu 205 selection to split out of the original snippet, into a newly created snippet. The new snippet will be in the same Project and have the same type as the original, but it will not inherit the original's relationships or Sequence memberships 115. The in-text reference to Profiles 116, if Profile feature is included in the embodiment, will always go where the superlinked text 165 is. Splitting a snippet will not change the original's Snippet Relationship 121, Sequence memberships 115, or anything other than the selected textual content 199 that is removed from it. There may be other user operations, such as Recycling, that can implicitly split a snippet that will be explained in the Recycling Section.

### (FIG. 10)

### 9. Ribbon 132 Operations

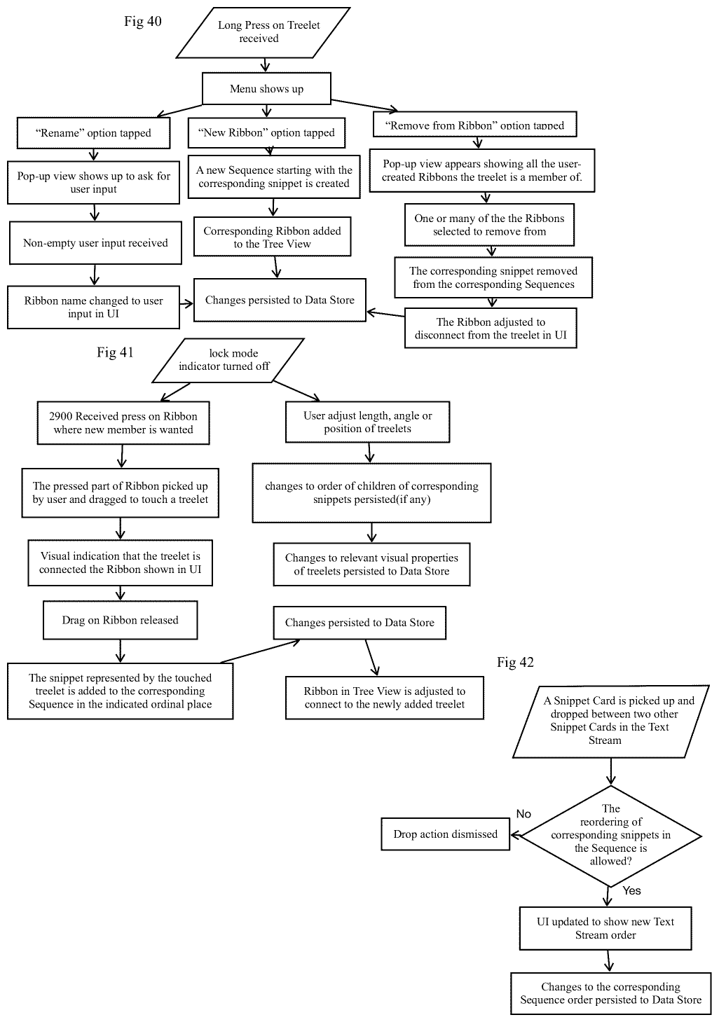

The user can choose and alter the appearances 134 of the Ribbons 132, as well as create, delete, rename or make other changes to them and the corresponding Sequences 128 directly in the Tree View. A default name 130 for the Ribbon 132 may be provided at creation. The user can later change the name 130. (FIG. 15) (FIG. 39) (FIG. 40) (FIG. 41)

### 10. Changing How the Treebranches and Treelets Look

In this embodiment, the user can change the length of a treelet, the position of a treelet on its parent and the rotation of a treelet, without causing changes to the underlying snippet and Snippet Structures.

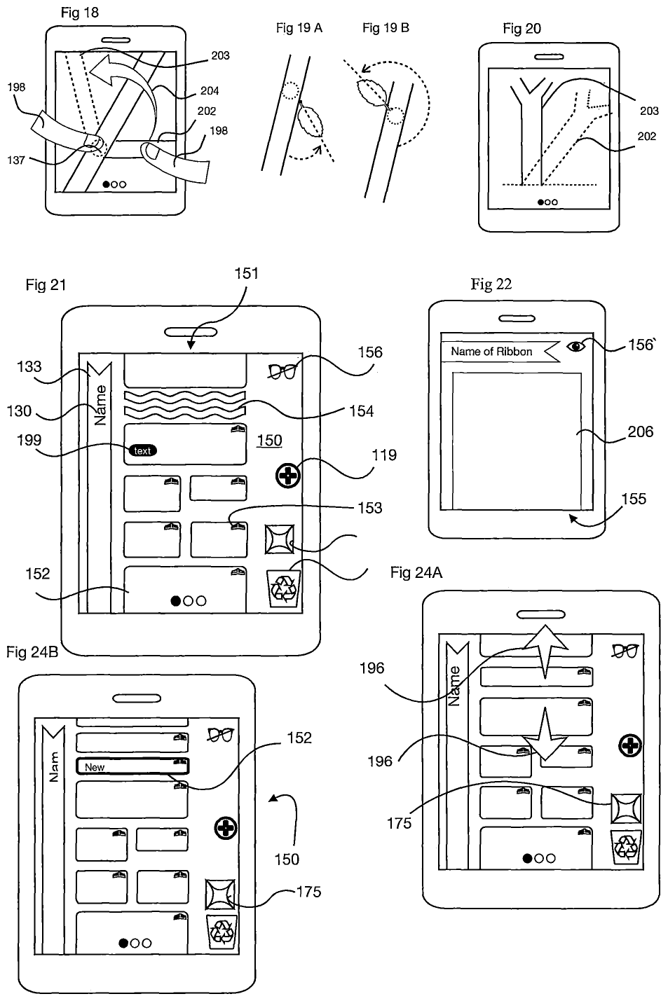

The user can use two fingers to adjust the length of a twig 142 or trunk 144 treelet by moving apart or together the fingers along the length of the twig or trunk. The position of a twig 143 or leaf 142 treelet can be moved up and down their parent treelet 138 by one finger dragging 197. It is also possible to change the color of the leaf treelets either automatically (e.g. the higher word count, the deeper color) or by user actions. Attach points 137 of treelets cannot overlap. All types of treelets can have their rotation degree adjusted by a twisting motion 204 with two finger on the treelet, while keeping one of the fingers on the attach point 137 if it is attached to a parent, and move the other to twist the treelet from one angle 202 to another 203. An “Lock Mode” button 149 can be included in the Tree View 135 to enable and disable adjusting those aspects of the treelet 136 and treebranch 141 properties. (FIG. 41) (FIG. 16) (FIG. 17) (FIG. 18) (FIG. 19) (FIG. 20)

### Text Presentation: Text Stream View

The APP presents Text Presentation mode 102 to show users the contents 106 of their snippets in a stream of texts. Many snippet Sequences 128 may co-exist in the same Project 103. The Text Presentation mode of a project is capable of showing these Sequences 128. Therefore the contents of snippets of a Project can be presented to the user in various different orders and subsets according to the Sequence. Such a presentation is called a Text Stream View 150. It is considered one of the main Views of the Project.

Sequences can be auto-generated or user-created. For user-created Sequences, or even some auto-generated sequences, their order of snippets can be altered in the Text Stream View. It is impossible to freely change a Sequence order if that Sequence is purely ordered by timestamps, such as time of creation 201, or time of last edit 20. However, in some embodiments, there are Sequences that are generated basing on or partially basing on Snippet Structures. In that case, the Text Stream View can allow user to at least partially change the Sequence's order in Text Stream View where the underlying Snippet Structures would be changed accordingly.

Beside the Sequence orders, the content of the snippets in a Text Stream View is also directly editable (unless a “view-only” mode 156 is turned on).

view-only mode 155 is offered in some embodiments. Once turned on, the Text Stream 151, which is the main part of the Text Stream View showing the snippets' contents, becomes view-only, and any underlying data cannot be altered, including the snippets, Sequences, or Snippet Structures.

In some embodiments where snippets may be presented with a highlighted state or different appearances 117 in Graphical Presentation 101, whether these states are shown and whether users are allowed to change those special visual states in Text Presentation 102 can vary in different embodiments.

In a preferred embodiment on touch devices, where the Sequences are presented visually as Ribbons, the Text Stream View 150 consists of the main section: the Text Stream 151, where the actual stream of snippet contents are shown; a side section, where a visually presented Ribbon 133 functions both as a scroll bar for the Text Stream and as a button for selecting which Sequence of the Project is being shown in the Text Stream View; and a set of buttons, icons, and other visual elements for new snippet creation, APP navigation, Recycle Bin, view-only mode 155 and possibly other functions. In Text Stream, a single element displaying the content of one snippet is referred to as a snippet card 152. The Text Stream thus consist of multiple snippet cards. (FIG. 21)

The Ribbon scrollbar/button 133 may display an appearance 134 that the user can alter and choose, which will not change the corresponding Sequence but will affect how the Ribbon looks both in the side section of Text Stream View and in the Tree View. These settings for this appearance are the same settings that affect how the Ribbon looks in Tree View.

View-only mode 155 is included in the preferred embodiment for Text Stream View. When turned on by an indicator button 156, the snippet cards representing the Sequence has no visual borders and all the contents are strung together as a whole, continuous text 206, like a traditional written work.

### (FIG. 22)

In this embodiment, aside from the usual user-created Sequences and Sequences generated by sorting on timestamps of all snippets in the Project, including time of creation 201 and time of last edit 200, there are also auto-generated Sequences based at least partially on Snippet Structures. Two of such Sequences are: a Sequence based both on time of creation 201 and Snippet Structures 127 of all the snippets of the Project 103; and a Sequence based both on time of last edit 200 and Snippet Structures 127 of all the snippets of the Project 103. They are generated in a similar way:

Firstly gather the Snippet Structure containing the trunk and all independent Snippet Structures together, including singular snippets not connected to any other, and sort them in timestamp order. The timestamp order is decided by finding the representing timestamp 157 of each independent Snippet Structure and compare them to sort them in ascending or descending orders. The representing timestamp 157 of a Snippet Structure is decided by comparing timestamps of every snippet on that Structure and use the one most appropriate. For time of creation 201, it is the earliest one. For the time of last edit 200, it is the latest one.

Secondly, flatten each Snippet Structure into a sub-Sequence 158 in a Depth-First Traverse manner. It is a similar process to merging a Snippet Structure into one snippet, except that the snippets are not merged, but simply strung into an ordered list which is the sub-Sequence 158. Then the auto-generated Sequence is created by stringing those sub-Sequences 158 together in the timestamp order. (FIG. 23)

The user can do various operations in Text Stream View 150: to alter content of member snippets, reorder member snippets of any user-created Sequence, remove snippets from Sequence, create, delete, split or recycle snippets, and move snippet cards to other Projects or into Recycle Bins. Also, the user can change the appearance properties of the representing Ribbon, name and rename the Ribbon, delete the Sequence, or switch to a different Ribbon and Sequence, or change the way the Text Stream looks without changing the underlying snippets, Snippet Structures or Sequence order. All of the user operations are only possible when the view-only mode is off.

### 1. Reordering Text Stream 151 to Change Sequence 128 Order

For user-created Sequences 128, the user can always reorder the snippet cards 152 in the Text Stream 151 when view-only mode is not on. It will change the underlying Sequence 128 order, but not any Snippet Structure.

For auto-generated Sequences 128, timestamp plus Snippet Structures determined Sequences 128 may partially allow users to change the Text Stream 151 order. However, for Sequences purely based on timestamps, reordering the Text Stream 151 by shuffling the snipper cards 152 is not allowed.

When allowed, the user can change Text Stream 151 order using the drag and drop gesture 197 on the snippet cards 152: picking up a snippet card 152 to drop it in the desired ordinal position in the Text Stream 151. Corresponding Sequence 128 order will change to match the Text Stream 151 order. Whenever moving a snippet card 152 to a position is not allowed, the app will dismiss such an attempt by the user. There are two auto-generated Sequences in this embodiment that allow Text Stream partial reordering: a Sequence 128 based both on time of creation 201 and Snippet Structures 127 of all the snippets 105 of the Project 103; and a Sequence 128 based both on time of last edit 200 and Snippet Structures 127 of all the snippets 105 of the Project 103. In both cases, only the reordering that merely changes a Snippet Structure's orders of children 125 to the same parent 126 is allowed. The order of sub-Sequences 158 can not be changed in reordering. FIG. 42 ABC shows an example of auto-generating a Sequence based on “time last edited” timestamps and Snippet Structures. The only allowed reordering is to exchange the order of child structures of snippet #1, resulting in a Sequence in order of (#6, #7, #1, #3, #2, #4, #5).

### (FIG. 42)

### 2. Create New Snippet

One way for user to create a new snippet in the Text Stream View 150 is to use the “create” button 119 that is present on the main Views of Project. In some embodiments, an option to launch the APP with a new Snippet View 118 is offered in the APP. When the most recently visited View before launch is the Text Stream View 150, the newly created snippet 105 will be saved to its Project 103.

Both of these operations are basically the same as described in the previous section of Graphical Presentation: Tree View. Both will lead to an empty Snippet View to show up where user can input content and choose snippet types. When the Snippet View is dismissed, if it is not empty, the new snippet will be saved in data store and the UI will update accordingly. However, although this new snippet is created in association to Text Stream View 150, it might not be added to the current Text Stream 151 and the underlying Sequence 128. A snippet card 152 will only be added to the current Text Stream if the Sequence is auto-generated and includes all the snippets of the Project 103. If the underlying Sequence is user-created, although the new snippet will be added to the Project 103, it is not clear at which ordinal position the user wants the snippet to be or even if the user wants it added to the current Sequence. Thus, a snippet card will not be added to the current Text Stream and the new snippet will not be connected to any Sequence or Snippet Structure at creation. (FIG. 43)

Another way that is unique to the Text Stream View 150 in creating a new snippet 105 is to use the spread gesture 196: the user may be allowed to use two fingers 198 to spread two adjacent snippet cards 152 apart to create a snippet. A new empty snippet card with editing focus will be instantly inserted between the two previously adjacent snippet cards 152. After that, the user can input content 106 to the empty snippet card 152. If the user failed to add any content before the editing focus is shifted off the new snippet card, it will be removed from Text Stream 151 and no actual new snippet will be created. If the user input some content 106, the new snippet will be saved to the data store. This way of creating a new snippet is only available in a Text Stream 151 of an user-created Sequence. And the newly created snippet will not be connected to any Snippet Structure 127 at creation, but will be added to the current Sequence in the ordinal position indicated by its order in the Text Stream 151: it will be placed between the two snippets 105 corresponding to the two previously adjacent snippet cards 152. (FIG. 43) (FIG. 24) (FIG. 25) (FIG. 26)

### 3. Delete Snippet

To delete a snippet from the Project in the Text Stream View 150, the user can long press on the corresponding snippet 105 card to call up a menu, where the “delete” option will appear and can be tapped to delete the snippet and remove the snippet card 152 from the Text Stream 151. This follows a similar process in the Tree View 135. Process can refer to the flow chart there except for the last step where instead of removing the corresponding treelet from Tree View, the snippet card will be removed from the Text Stream View. (FIG. 44)

It is noted that deleting a snippet is very different from removing a snippet from a Sequence 128. Snippets remove from Sequences still exist in the Project, but once deleted, not only will the snippet be removed from the Sequence 128, it is deleted from the Project 103 all together.

4. Removing Snippet from Sequence

User can remove a snippet from the current Sequence shown in the Text Stream View 150 without deleting it from the Project or recycling it. So it still remains in the data store and shown in other main Views of the Project like the Tree View 135. Removing snippets from Sequence is only possible when view-only mode is not on and it must be a user-created Sequence. Auto-generated Sequences 128 can not have their snippets removed without deleting it from the Project or recycling it into the Recycle Bin 177. The way to remove a snippet from the current Sequence 128 in the Text Stream View 150 can be implemented by long pressing on the corresponding snippet card and select the option to disconnect it from current Ribbon and thus the snippet 105 will be removed from current Sequence 128.

When user tries to disconnect a snippet card in a Text Stream View of an auto-generated Sequence, it should not be allowed. (FIG. 44)

### 5. Move a Snippet to Another Project or Recycle it

Any recycling or changing of Project statuses must make sure that all the snippets on the same Snippet Structure 127 must have the same Project and Recycle statuses 113, 114. Unlike in Tree View 135 where user can easily distinguish visually whether a treelet 136 is independent or not, it makes sense that in the the Text Stream View, as long as not in view-only mode, every snippet card can be dragged around. The decision whether a drag and drop operation is allowed will be determined after the drop happens. In the case of recycling or moving a snippet to another Project 103, if a user drag and drop a snippet card onto the Recycle Bin element 178 present on the Text Stream View, or into a main View of another Project or the Recycle Bin View 179, the APP will decide whether the changing of Recycle and Project statuses 113,114 for the corresponding snippet is allowed by finding out whether the snippet is independent of any relationships 121 and if not, asking the user to clarify intention. If a snippet is recycled or moved to another Project 103, not only will it be removed from the current Sequence, but all its memberships of Sequences in the previous Project and all its relationships 121 will be deleted.

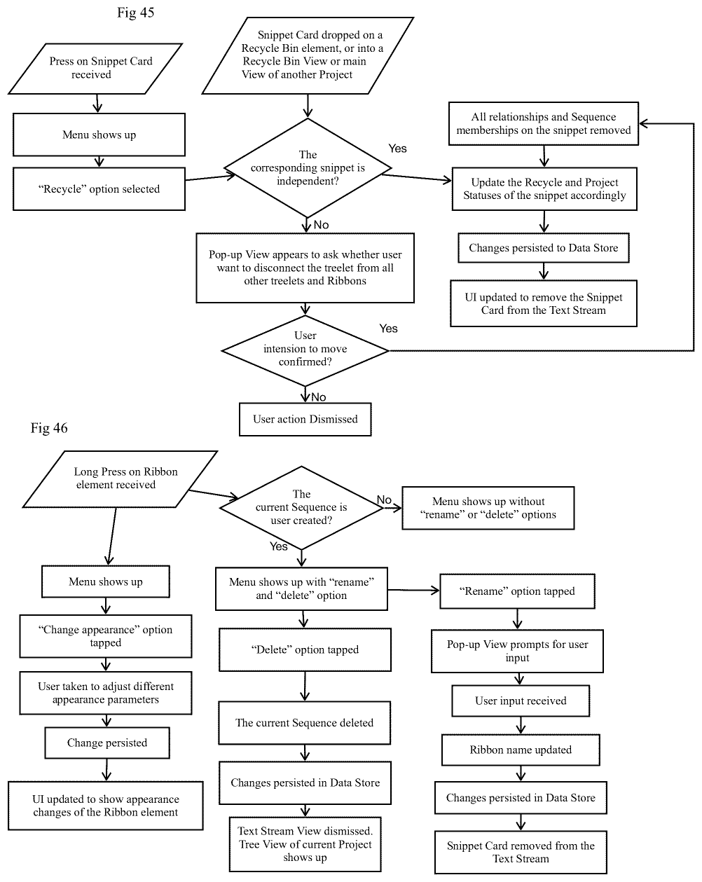

### (FIG. 45)

### 6. Split Snippet

The user can also split selected text 199 out of an existing snippet 105 in the Text Stream View 150 if not in view-only mode. As previously mentioned, splitting a snippet is possible wherever the snippet's content 106 can be edited, and the snippet cards are all editable in the Text Stream. Implicitly splitting a snippet by choosing to recycle the selected text is also possible in Text Stream View. How the split is done is similar to splitting a snippet described in the Graphical Presentation: Tree View section, except that there is no need to navigate to individual Snippet View first when contents 106 can be directly edited in snippet cards. Because it is also a process that creates a new snippet, it will also follow steps described in creating new snippet earlier in this section on whether a new snippet card 152 will appear in the current Text Stream 151 based on whether the current Sequence 128 is user-created or auto-generated. (FIG. 43) (FIG. 38) (FIG. 21)

### 7. Switch to a Different Sequence 128

In this Text Stream mode, there is a Ribbon visual element 133 that functions both as a scroll bar and a button. Once it is tapped, a selector View will appear showing all Sequences 128 of the Project 103. When the user tap one of them, the Text Stream View 150 will update to show the newly selected Sequence 128.

### (FIG. 49)

### 8. Long Press on the Ribbon 133

In this Text Stream mode, there is a Ribbon scrollbar/button 133 that functions both as a scroll bar and a button. Long pressing on it will call up a menu with various options, including but not limited to:

### (1) Rename a Ribbon

If the current Sequence 128 is user-created and can be named in the embodiment, the menu will show up with an option to rename the Ribbon. Once the option is tapped, the user will be prompt for the new name. (FIG. 46)

### (2) Delete the Sequence

If the current Sequence 128 is user-created, the menu will show up with an options to delete the Sequence. Once the option is tapped, the current Sequence will be deleted and the APP will automatically navigate to the current Project's Tree View 135. (FIG. 46)

### (3) Change the Appearance Settings of the Ribbon

As mentioned before, the Ribbon scrollbar/button 133 may display an appearance 134 that the user can alter and choose, which will not change the corresponding Sequence but will affect how the Ribbon visually looks for this Sequence both in Text Stream View 150 as the Ribbon scroll bar 133 and in the Tree View 135 as the Ribbon element 132. However, it may be prohibited to change Ribbon appearances for auto-generated Sequences in some implementations, since auto-generated Sequences are already not visually shown in the Tree View and are only shown as scrollbar/button 133 in the Text Stream View.

Because these appearance settings 134 of Ribbon is the same, the same View handles them whether it's from Text Stream View or Tree View 135. (FIG. 46)

### 9. Change the Way the Text Stream 151 Looks

In the preferred embodiment, the user can also make changes to how the Text Stream 151 looks without changing the underlying snippets, Snippet Structures, Sequences or Ribbon appearance settings.

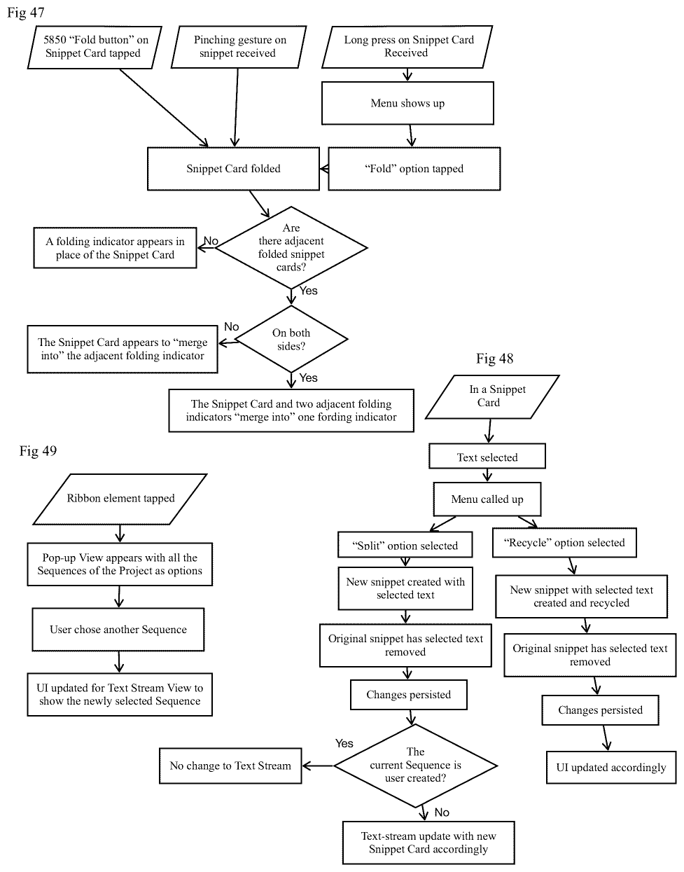

Firstly, the user can fold adjacent snippet cards 152 together. A visual element referred to as “folding indicator” 154 will be displayed in the place of the folded snippet cards to indicate. a portion of the Text Stream has been folded. All adjacent folded snippet cards 152 will be indicated by the same folding indicator 154 and when a new snippet card 152 is folded adjacent to a folding indicator 154, they are automatically folded into the same indicator. There can be multiple folding indicators in the Text Stream separated by unfolded snippet cards. If all the snippet cards between two folding indicators are folded, the View will update and there will only be one folding indicator left. The folding indicator 154 will also serve as a button to unfold its folded portion of the Text Stream 151. Once tapped, all the adjacent folded snippet cards 152 indicated by the same folding indicator 154 will unfold at once and appear in the Text Stream 151, and the tapped folding indicator will be removed. To fold a snippet card 152, a pinching gesture on the card or tapping on a “fold button” 153 on the card can be performed. Alternatively, long press on the card to call up a menu that offers a “fold” option can also be implemented. (FIG. 47) (FIG. 21)

Secondly, the user can arrange adjacent snippet cards 152 to be horizontally next to each other instead of vertically in line. The horizontal arrangement is limited in pairs of two in this embodiment. However, one or multiple pairs of snippet cards can form a horizontal arrangement block 159. It can be implemented in this way: if a new adjacent card 152 is dragged into a horizontal arrangement block 159, then in the opposite end from where the new card is dragged 197, the card at the end point of the block 159 can be “expelled” back into vertical arrangement to make room for the newly joined card. The user can use drag and drop to arrange the snippet cards in this way. There are also other ways to implement dragging and dropping snippet cards into the horizontal arrangement block 159, for example the direction of expelling can differ or that it can simply be allowed for single snippet card to exist at wherever position the user drops it.

Note that it is possible to change Sequence 128 order and possibly Snippet Structure 127 if the snippet card is dropped into a position that will change the Text Stream Order. This is handled as discussed earlier in reordering Text Stream.

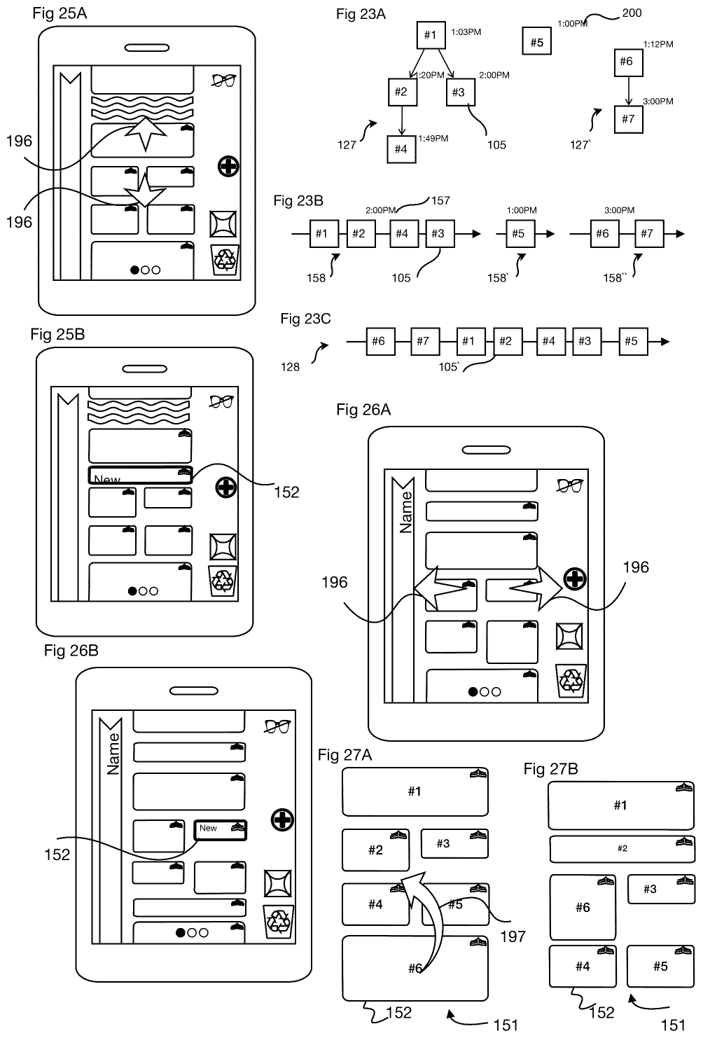

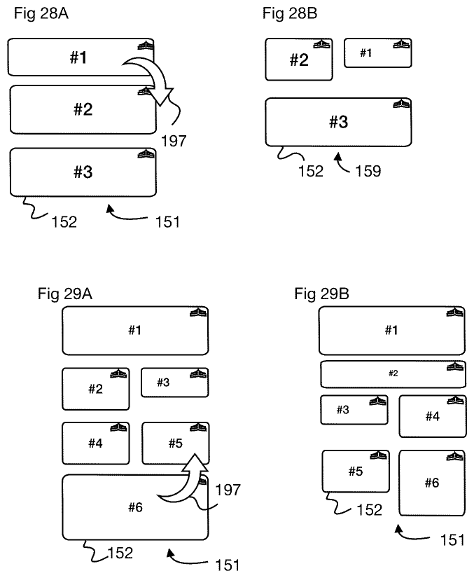

### (FIG. 27) (FIG. 28) (FIG. 29)

### 10. Highlighted Snippet Cards and Similar Special Visual Effect on Snippet Cards

In some embodiment, visual representations of snippets can be highlighted or have other visual effect as described in the Tree View Section. Such special visual effect can be shown on the snippet cards as well.

### 11. Additional Features

In some embodiments, when a snippet of a Sequence has children 125 not on the same Sequence, option to show its children structures under the parent snippet card in the Text Stream 151 in a view-only and visually distinguished manner, is made possible for every snippet card in the Text Stream. User should be allowed to manipulate the Text Stream 151 to show and dismiss such visual elements displaying such child structures.

### Profile and Profile Library

The Profile Library 175 is a system for sharing user-defined data unit referred to as Profiles 160 between Projects 103. The APP provides the frame for the information units called Profiles for the user to fill in. The Profile function enables the user to define anything of interest to them for their works. The UI is designed such that all Profiles 160 are collected in the Profile Library 175 and the Profile Library 175 is accessible from every main View of a Project.

A Profile 160 can be created from the Profile Library View 176 which has a new profile button 174. It is possible to delete a Profile both in the Profile Library View 176 and the individual Profile View 162. A profile can be linked to or referenced in a snippet 105. The user will be able to create such a link or reference in the snippet and later access the Profile 160 through the link. Such a link or reference can be in-text or collected in a certain area of the Snippet View 118. The Profiles 160 and their links with snippets 105 should all be persisted in data store. The link will be deleted if the linked Profile or snippet is deleted.

In some embodiments, the user can create multiple Profile Libraries, each associated with a subset of all the Projects in the APP. Access to Profile linking is limited to snippets in the Projects associated with the Profile Library that particular Profile belongs to.

However, in the preferred embodiment, there is only one Profile Library that holds all the Profiles and they are accessible from any Project.

In this embodiment, the link between a snippet and Profile is bi-directional. The link in the snippet is in-text as a superlink 165 and this superlink 165 is bounded to text. Once the superlink 165 is tapped, it will show the linked Profile in a smaller simplified Profile View. An auto-generated link from the Profile to the snippet will be collected at the bottom section of the full Profile View called List of References 170. If such a link is tapped, a Snippet View will appear and show where the superlinked text 165 is. The link is created in the snippet by the user and after the user created the in-text superlink to a Profile, a reference link back to the snippet is automatically created and added to the Profile View's List of References. A Profile can be linked to from multiple snippets, and even multiple places in the same snippet. A snippet can also link to multiple Profiles 116 as it can contain multiple superlinks in its text content.

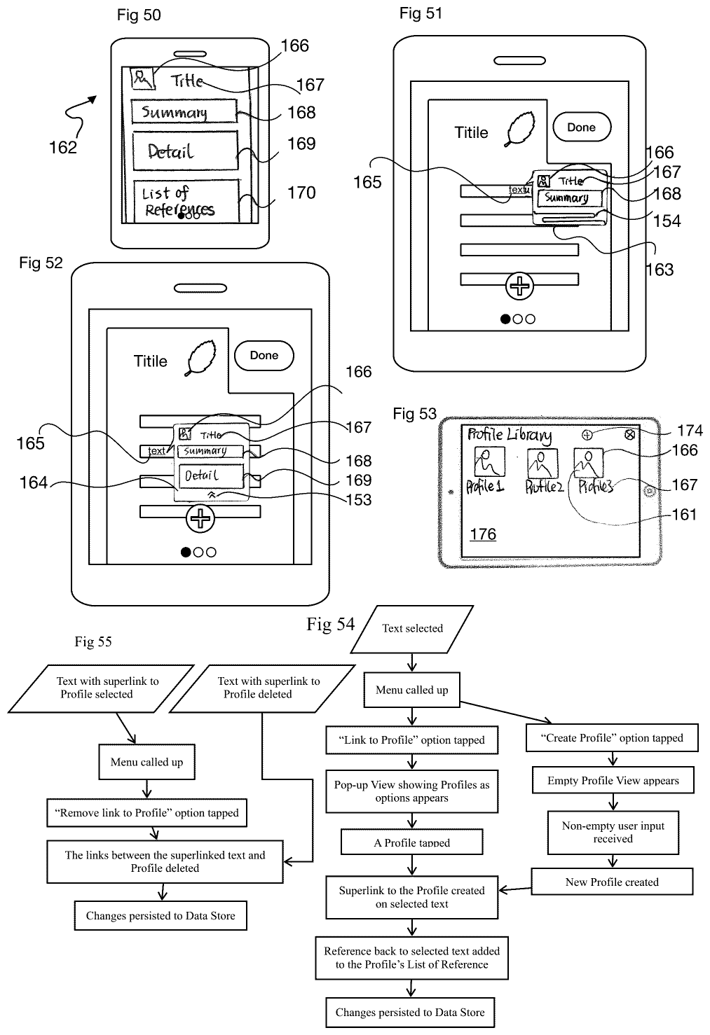

The full Profile View in this embodiment has a picture 166, a Title text field 167, a Summary text field 168, a Detail text field 169 and a List of References 170. All sections are editable and entered by the user except the List of References. There are also three variations to show the Profile: a full version referred to as Profile View, an abbreviated version without Detail and List of References, and a less abbreviated version without only the List of References. Let's refer to the later two as Short Profile Card View 163 and Profile Card View 164. (FIG. 50) (FIG. 51) (FIG. 52)

When a superlink 165 to a Profile is tapped from a snippet, a Short Profile Card View 163 of the linked Profile is shown like a “card” floating on top of the view beneath. When the user taps the folding indicator at the bottom of the “card”, it expands vertically to the less abbreviated Profile Card View 164. When the user taps the fold button 165 at the bottom of the Profile Card View, it folds back to the Short Profile Card View.

The full version of the Profile is shown in full Profile View 162. It can be navigated to from inside the Profile Library (FIG. 53) by tapping on a visual element 161 representing the Profile. It may also be navigated to by tapping either the Short Profile Card View 163 or the less abbreviated Profile Card View 164 anywhere that is not the fold button or folding indicator.

The full Profile View is editable while the abbreviated and less abbreviated “cards” are view-only.

In some embodiments, the superlink 64 to Profile is not limited to only from within Snippets, but Profiles can link to each other as well.

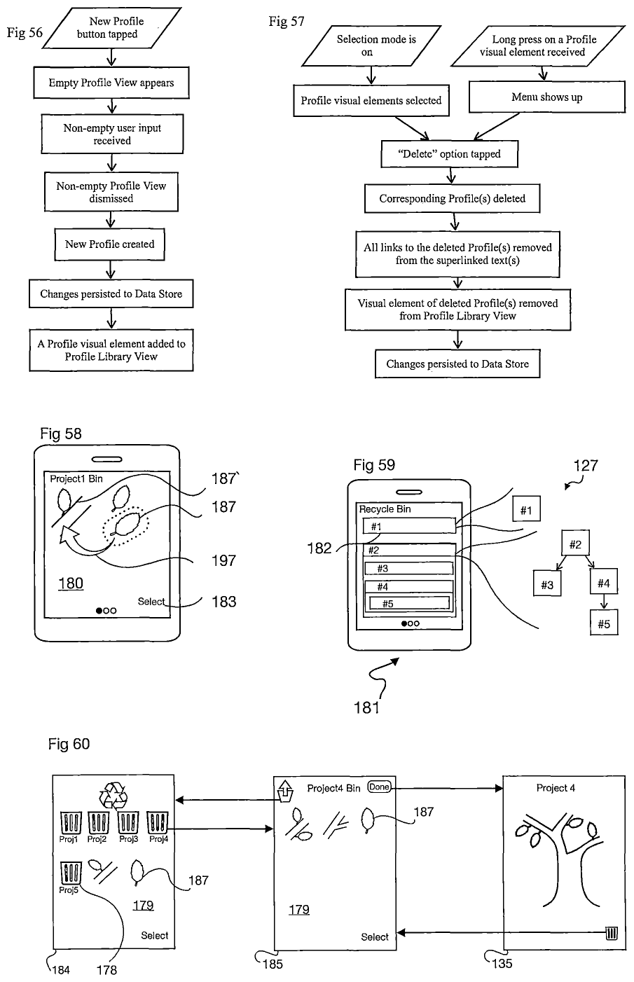

Various user-actions regarding the Profile system can be performed in the example embodiment, such as creating a Profile, deleting Profiles, creating an in-text superlink to a Profile, and removing a superlink to a Profile which will lead to the auto-removing of the corresponding reference link in the Profile View. (FIG. 54) (FIG. 56) (FIG. 57) (FIG. 55)

### Recycling and Recycle Bin

To enable users to easily recycle written texts, Recycle function is offered in the APP for user to recycle snippets 105 and Snippet Structures 127 into the Recycle Bin 177 that can be accessed from every Project's main Views. This relieves the user of the stress of forced decision regarding their snippets at any point of the writing process. It can be as simple as a simple collection of texts, or as complicated as containing all the structural and other information of the recycled snippets. Recycled snippets or Snippet Structures are no longer shown in the Project's main Views. Instead, they are shown in the Recycle Bin View 179.

The user can easily move a snippet 105 or Snippet Structure 127 in and out of the Recycle Bin 177, changing its Recycle status. When a Snippet Structure is recycled, all the snippets on it are recycled. When it is not, all the snippets on it are not. The user can also delete recycled snippets or Snippet Structures from inside the Recycle Bin View 179. Because of how the Recycle Bin 177 is accessible to any Project, snippets and Snippet Structures can migrate to different Projects through recycling and unrecycling.

The Recycle Bin View 179 can have two modes; a graphical mode 180 and a text-list mode 181. In the graphical mode 180, all the snippets and Snippet Structures are presented in the same way as in the Graphical Presentation of the Project, and their content can be viewed through navigation to individual Snippet Views 118 by tapping the recycled element. In the text-list mode 181, all the snippets and Snippet Structures are shown in a list of structured units of text. The structuring of the snippets is shown by the framing of the text units 182. In some embodiments, only one mode is included, while in others both modes are included. (FIG. 58) (FIG. 59)

In some embodiments, there is a system of Recycle Bins. For each Project, there is an associated Project Bin. In such a system, even after the recycled object no longer appearing in the Project's main Views, their Project statuses are kept. There is also a Common Bin 184 to collect the recycled objects that are not in any Project. (FIG. 60)

(The system of Bins may purely be a visually presented system while the data structure may be much simpler.) (FIG. 1)

In some embodiments, the Profiles 160 from the Profile Library 175 can also be recycled and collected in the Recycle Bin 177 alongside other recycled objects. The user can perform the Recycle, Reorder, Restore, and Delete on them as well.

In a preferred embodiment on touch devices, the Profiles 160 cannot be recycled and only the graphical mode 180 for Recycle Bin View is included. Within the Recycle Bin View 179, everything including independent, free-to-move treelets and whole treebranches are considered as singular objects except when individual treelet is tapped to view its content. For convenience, let's refer to such a recycled snippet or Snippet Structure (or Profile in some embodiments) as a recycled object, and its visual representation in the Recycle Bin View 179 a recycled object element, which are basically recycled treelets and treebranches (or Profile visual elements 161). Altering the snippets as well as the structuring of snippets is not allowed within the Recycle Bin. Generally, the user can do a very limited number of operations related to the Recycle Bin, including but not limited to: Recycle, Reorder, Restore, and Delete.

### 1. Recycle

There are various means to recycle a snippet 105 or a Snippet Structure 127 described in this disclosure. How the recycle is performed can be found in details in the Tree View section and the Text Stream View Section. It is noted that in embodiments with a system of Bins, a recycled object can be drag-and-dropped into a different Bin View as well, changing its Project alignment.

### 2. Reorder

The recycled objects 187 can be repositioned inside the Recycle Bin View 179 with drag and drop.

### (FIG. 68)

### 3. Restore

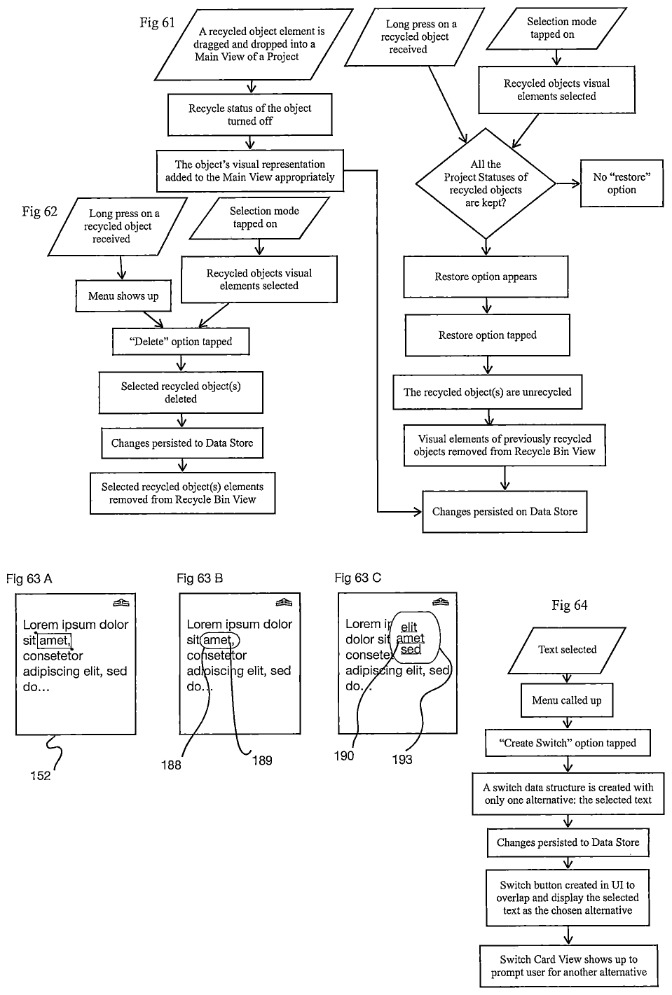

A recycled object 187 can always be restored and not necessarily to the same Project 103 it was recycled from. There are multiple ways to restore a recycled object: it can be done by dragging and dropping a recycled object 187 out of Recycle Bin View 179 and into a Project's main Views. (FIG. 61) When there is a system of Recycle Bins that keeps Project statuses 113 after objects are recycled, the recycle can be done by long pressing on a recycled object 187 to call up a menu and tap the “restore” option. The user may also chose to restore all recycled objects in a bin, or turn on the selection mode, for example by tapping on a “select button” 183 in the Recycle Bin View 179 and select some recycled object 187 to restore. However this won't work in a common Bin 184 that doesn't keep the Project status 113 of the recycled objects. (FIG. 61)

### 4. Delete a Recycled Object 187

The user can delete a recycled object in Recycle Bin View, for example by long pressing on its corresponding visual element, calling up a menu and then choose the “delete” option. Another way is to delete multiple recycled objects 187 at once using the selection mode. (FIG. 62)

### Habit Forming System

In some embodiments, a habit forming system is integrated to encourage users to keep writing and using the APP.

### 1. Notifications

One aspect of this system is notifications. The APP will send notifications to the user device periodically to remind the user to use the APP. It should provide easy to follow advices or instructions based on user's using habits. It is possible for the user to customize the system to focus on one Project or a few Projects instead of the using habits of the entire APP.

### 2. Rewards

Another aspect of the system is the rewards given to the user based on their using habits of the APP. For instance, whether the user followed the advice given in the notifications or if the user has been consistently putting in new content in a selected Project. Rewards can be given and taken away based on certain standards.

In one embodiment, the reward is sets of decorative visual elements 194 added to the Snippet View's 118 background. If the user is following the advice from the notification or putting in words everyday, then each day a decorative element 195 is added to the background until a certain amount is reached and the process starts anew with a new set of decorative elements 194′. The earned rewards of the last set will be converted to a special reward background that the user can use.

Otherwise, if the user doesn't use the APP two days in a row, all the accumulated decorative elements of the current set the user has earned will be cleared and the process starts anew with the same set.

A slightly different standard for rewards can be, for example, instead of clearing all the accumulated decorative elements all at once, the number of elements can be reduced if the user failed to use the APP above the pre-defined threshold. (FIG. 69) (FIG. 70) (FIG. 71)

### Switching Text

A writer often faces the hurdle of editing their writings into a better versions. In doing so, many expressive iterations of same or similar meanings can be created. The writer may not know which iteration is the best fit at the moment and want to keep several expressive iterations as options. Thus enters the Switching Text function.

The Switching Text function enables the user to select a portion of text 199 and create a “switch button” 188 on it, which is a visual element that overlaps with the selected text 199. The switch button 188 sits within the context of the background text and displays a text that is the currently chosen text alternative. The chosen text is therefore displayed as if it is part of the larger textual background. For convenience, let's refer to this chosen alternative text as the “text on-display 189.” The button is visible and indicates that alternative options exist for the text it overlaps with. At the same time it also functions as a switcher between the alternatives.

Once a switch button 188 is created, an instance of the data structure called a “Switch” 191 is created for it that can store many different alternative texts 190 and having one of them as the chosen alternative that is displayed on the corresponding switch button. The chosen text (“text on-display” 189) and the alternatives 190 can continuously be edited from UI after the switch button is created. Like the superlinks, this text switch button 188 along with its text alternatives 190 will go with text if copied and pasted.

(FIG. 63) The very first text on-display 189 will be the originally selected text 199 on which the switch button 188 is created. The user can then enter other alternative texts into the “Switch.” 191

Basically, the Switch data structure 191 is consisted of an ordered list of alternative texts 190, a chosen text indicator 192, and data required to match it to where the switch button 188 should be.

The user can perform various actions on the switch button 188, for example: swipe up and down on a switch button 188 to switch between the alternative texts 190 stored in the corresponding “Switch 191,” tap on the switch button 188 to show all the alternative options 190 in a Switch Card View that floats above the current View, select the alternative to display by tapping on the option, swipe left on an alternative option in the switch Card View to reveal an edit and a delete button, tap the delete button to delete that alternative, tap the edit button to edit that alternative, swipe up twice in quick succession on the Switch Card View or swipe to the bottom of the it to reveal a textfield to enter a new alternative, and tap outside the Switch Card View to dismiss it. If the user want to keep only the on-display text and delete all other alternatives at once, they can long press on the switch button to call up a menu and tap the “delete” option and the switch button 188, the “Switch 191,” together with all the other alternative texts not on-display will be deleted.

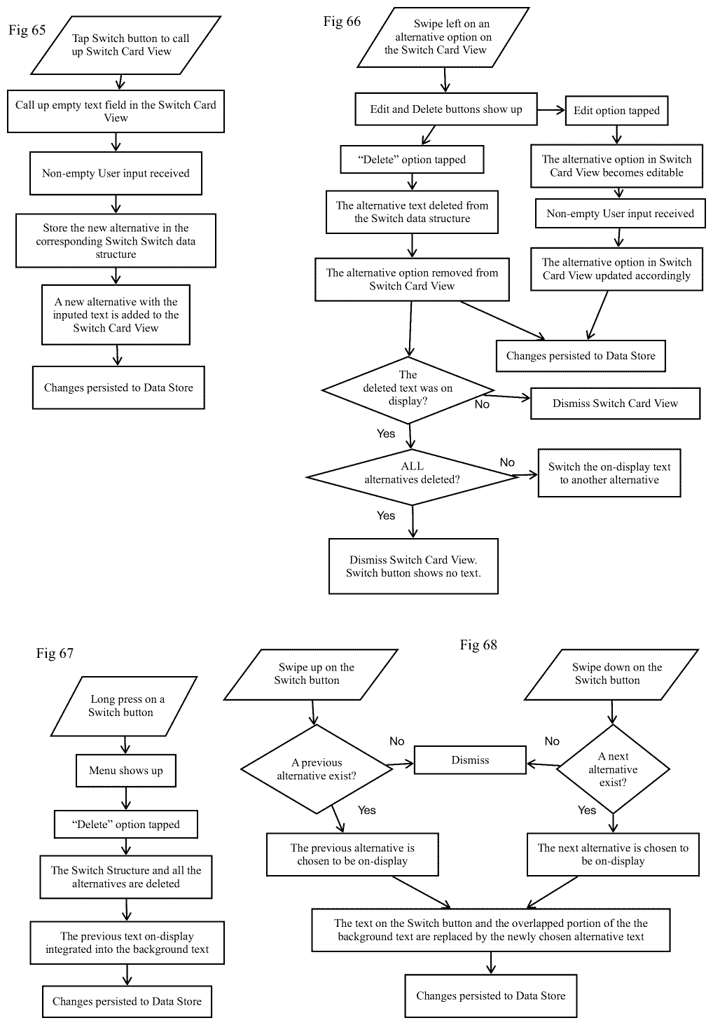

### (FIG. 64) (FIG. 65) (FIG. 66) (FIG. 67) (FIG. 73) (FIG. 68)

### Change Tracking

In some embodiments, change tracking is implemented for user activities in the APP. Examples of user activities include but are not limited to: change contents of snippets, create or delete Projects, make changes to snippet Sequence orders, altering Snippet Structures, recycle anything, edit Profiles, etc.

Whenever user makes a change to affect persisted data in the APP, the change will be recorded by the APP in a tracking history, and the user can undo or redo those changes.

In some embodiments, user can choose to clear part or all of the tracking history. Another option is to have the history auto-cleared periodically or between APP launches. It is preferred to give user the choice of how to handle keeping the tracking history.

### Versioning and Auto-Versioning

In some embodiments, versioning function is included in the APP. “Versioning” means a version of the current state of the APP or part of it, such as a current state of a Project, the Profile Library, or the Recycle Bin, is stored in data store as back up.

If versioning function is included, it is best used in supplement to the change-tracking feature and less frequently visited by the user, but it can also exist independent of the change-tracking feature, or even as a replacement for it.

Versioning can be managed automatically and periodically, but the user should also have the option to manually back up a version, and to delete past versions no longer needed. User should also has the option to turn off the auto-versioning.

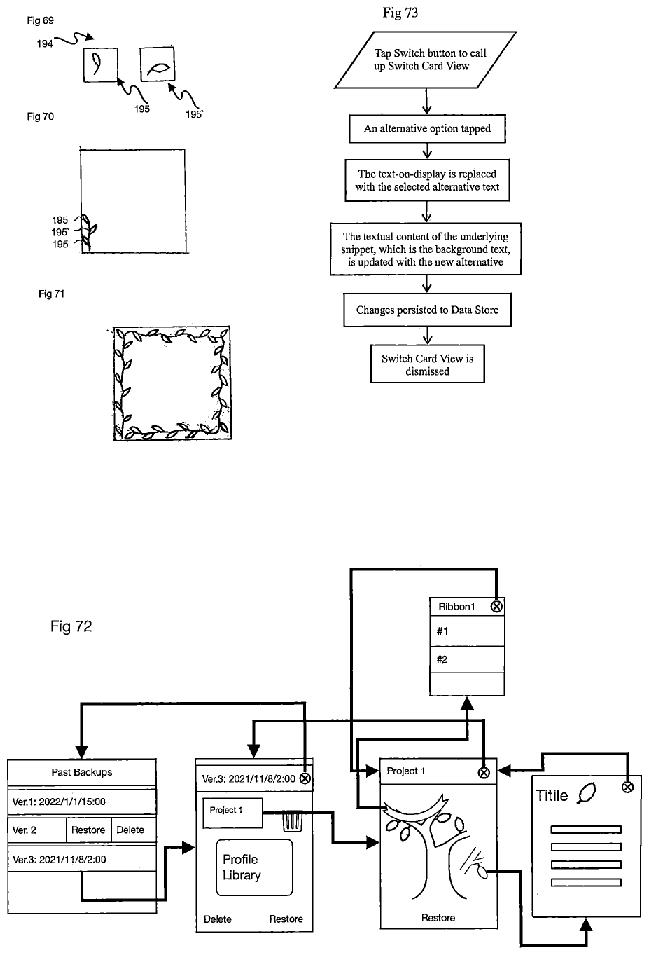

User can view the stored versions and choose to restore the APP's current state, or part of it, to a previous version. Preferably, a new backup version will be automatically saved before the current state of the APP, or part of it, is replaced by a past version. (FIG. 72)

### Other Features

The present disclosure doesn't exclude common writing software features such as but not limited to word count, search function, tags, exporting works to various formats, cloud storage and sharing, etc to be combined with any of the embodiments enabled by this disclosure. Future development on multi-users collaboration should be anticipated.

### Data Integrity Rules and Object Graph

In this section, a set of rules in supplement to the data object graph (FIG. 1) of a database for an example embodiment is provided. Note that the “relationship” in the data object graph does not refer to the snippet relationship defined in this disclosure, but just a common term used in database designs. This example embodiment has included many but not all of the features explained earlier in this disclosure and the object graph is for an object-oriented database operation system, which can be used to create and manage the database system for the APP. It is not intended to be the only possible implementation of data persistence and those rules are not meant to be comprehensive or the only interpretation possible. Rather, this set of rules is only a possible set of rules among the many embodiments enabled by this disclosure. However, it should be sufficient to demonstrate how such rules ensuring data integrity can be constructed. Based on these rules, what can and cannot be changed from UI should be made clear.

1. The set of snippet types and snippet relationship types: {Leaf, Branch, Trunk, {Branch, Leaf}}, {child-to, parent-to}
2. How many types a snippet can be simultaneous? {A snippet must be of one of the three singular types or the only double type}
3. Are relationships to-one or to-many? Is there an upper limit? Child-to is to-one and parent-to is to-many with no upper limit, and they are mutually reverse relationships.
4. Are relationships ordered? Children snippets of the same parent are ordered.
5. Are there any restrictions between a snippet's Project and Recycle status?
A snippet can be either in one Project or in no Project and recycled.
There can be no more than one not-recycled Trunk in a Project.
   6. Are there restrictions between snippet type and relationship?
a. A Leaf cannot have a child snippet.
b. A Trunk cannot have a parent snippet.
c. A Branch or a Branch+Leaf can have both snippet relationship types.
   7. Are there rules regarding snippet relationship and project status?
a. All related snippets must be either all in the same Project and not recycled, all in the same Project and Recycled, or all of no Project and Recycled.
   8. All snippets on a Sequence must be in the same Project the Sequence belongs to and not recycled.
   9. Only snippets and Snippet Structures can be recycled. Profiles cannot be recycled.
   10. Delete rules are as follow:
If a Project is deleted, all its snippets and Sequences are deleted.
If a snippet is deleted, all its Sequence memberships, relationships to other snippets, and the links between the snippet and the Profiles it referenced are deleted.
Project memberships are not automatically deleted by recycling, but can be deleted after a snippet or Snippet Structure is recycled.
If a Sequence is deleted, all its member snippets are not affected except that their memberships to the deleted Sequence will be deleted.
If a Profile is deleted, all the links between the Profile and the snippets that referenced it are deleted. So are the links between the deleted Profile and all associated Projects.
Additionally, if a snippet's Project or Recycle statuses is changed, all its Sequence memberships will be deleted.
Other than what are stated above, singularly deleting a Project, snippet, Sequence, superlink, or Profile should not cause the deleting of another Project, snippet, Sequence or Profile.

### LIST OF REFERENCES

presentation mode 1
presentation mode 2
Project
Snippet
Snippet content
snippet types set
Leaf type snippet
Branch type snippet
Trunk type snippet
Snippet title
Root type
Project Status
Recycle status
Sequences Membership
Linked Profiles
Appearances
Snippet View
New snippet button
snippet type indicator
Snippet Relationship
snippet relationship types
child-to relationship,
parent-to relationship
children snippet
parent snippet
Snippet Structure
Snippet Sequence
Host Project of Sequence
Ribbon name
Ribbon element,
Ribbon scrollbar/button,
Appearances
Tree View
treelet
attach point
parent treelet
Main tree
Independent treebranch or treelet
treebranch
leaf-like treelet
twig-like treelet
trunk-like treelet
a twig with a leaf
Child treelet
Cutting tool button
Select tool button
Lock mode button
Text Stream View
Text Stream
snippet card
Fold button
Folding indicator
view-only mode
View-only indicator button
representing timestamp
sub-Sequence (derived from an entire Snippet Structure)
horizontal arrangement block
Profile
Profile visual element
Profile View
Short Profile Card View
Profile Card View
in-text superlink to Profile
Profile Image
Title text field
Summary text field
Detail text field
List of References
New profile button
Profile Library
Profile Library View
Recycle Bin
Recycle Bin element
Recycle Bin View
Recycle Bin graphical mode
Recycle Bin text-list mode
text units
Selector button
Common Bin

Project Bin
recycled object
switch button
text on-display
alternative texts
“Switch” data structure
chosen text indicator
Switch Card View
Reward element set
Reward element
Spread gesture directions
Drag gesture direction
Fingers
Selected text
timeLastEdited timestamp
timeofCreation timestamp
Position/angle before movement
Position/angle after movement
Rotation gesture direction
Menu on selected text
206. Continuous text

This patent application is based on the provisional application No. 63/329,475 by Qiyue Zhang

1. A computer-implemented method comprising:
storing textual inputs by user into units of predefined data structures referred to as snippets in Data Store whether on a general computer device or an external storage unit;
grouping snippets into user created groups referred to as Projects that each represents a work of authorship that are persisted and changeable in the Data Store;
within one Project, organizing snippets by a set of relationships between snippets, the orders of such relationships and snippet types, wherein said snippet relationships, snippet relationship orders and snippet types are all persisted and changeable in the Data Store;
within one Project, organizing snippets by ordered lists referred to as Sequence, which are persisted and changeable in the Data Store, either by user creation or by auto-generation based on properties of the snippets such as timestamps of creation or last edit, snippet relationships, snippet relationship orders or snippet types;
showing in user interface the user inputs of snippet,
wherein the user inputs of the shown snippet can be changed and updated in Data Store, and
the shown snippet's type can also be changed and updated in Data Store;
showing in user interface a graphical rendering of Project inside a virtual canvas contained in the UI instance referred to as Graphical View that makes clear the existence of snippets, snippet relationships, snippet relationship orders and snippet types, as well as the user-created Sequences and how they connect snippets,
wherein each graphical element representing a snippet has its appearance settings, and its location within the frame of said virtual canvas, changeable and persisted in the Data Store,
said virtual canvas can be zoomed in and out to view the graphical rendering of the Project in various levels of details, and
the graphical elements representing snippets and Sequences can be manipulated in the Graphical View to change the snippet relationships, their orders and the user-created Sequences;
showing in user interface a rendering of Sequence contained in the UI instance referred to as Text Stream View where the textual user inputs stored in the snippets of the Sequence are shown consecutively, in the order of the Sequence,
wherein any Sequence of a Project can be shown in the Text Stream View, and it is possible to switch between different Sequences of a Project to be shown in Text Stream View without leaving the Text Stream View.

2. The computer-implemented method of claim 1,
further comprising:
showing a type of user-implementable UI element referred to as “Switch” that overlays with a portion of the background text, wherein the overlaying element can display several versions for the overlaid text.

3. The computer-implemented method of claim 1,
further comprising:
storing multimedia inputs by the user into units of predefined data structures referred to as Profiles in Data Store whether on a general computer device or an external storage unit, wherein the user can link such profiles from other text displays within the APP.

4. The computer-implemented method of claim 3,
further comprising:
showing a type of user-implementable UI element referred to as “Switch” that overlays with a portion of the background text, wherein the overlaying element can display several versions for the overlaid text.

5. The computer-implemented method of claim 1,
further comprising:
migrating snippets into different Projects by user operation directly from UI and updating such changes in Data Store.

6. The computer-implemented method of claim 5,
further comprising:
migrating snippets into specially designed groups referred to as Recycle Bins,
and showing a specially designed UI View that displays such groups to the user wherein users can freely move snippets in and out of the Recycle Bins.

7. The computer-implemented method of claim 6,
further comprising:
showing a type of user-implementable UI element referred to as “Switch” that overlays with a portion of the background text, wherein the overlaying element can display several versions for the overlaid text.

8. The computer-implemented method of claim 5,
further comprising:
storing multimedia inputs by the user into units of predefined data structures referred to as Profiles in Data Store whether on a general computer device or an external storage unit, wherein the user can link such profiles from other text displays within the APP.

9. The computer-implemented method of claim 8,
further comprising:
showing a type of user-implementable UI element referred to as “Switch” that overlays with a portion of the background text, wherein the overlaying element can display several versions for the overlaid text.

10. The computer-implemented method of claim 9,
further comprising:
migrating snippets into specially designed groups referred to as Recycle Bins,
and showing a specially designed UI View that displays such groups to the user wherein users can freely move snippets in and out of the Recycle Bins.

10. A system comprising:
a non-transitory computer-readable storage medium storing computer-executable instructions; and
one or more hardware processors in communication with the computer-readable memory, wherein the executable instructions, when executed by the one or more hardware processors, cause the one or more hardware processors to at least:
storing textual inputs by user into units of predefined data structures referred to as snippets in Data Store whether on a general computer device or an external storage unit;
grouping snippets into user created groups referred to as Projects that each represents a work of authorship that are persisted and changeable in the Data Store;
within one Project, organizing snippets by a set of relationships between snippets, the orders of such relationships and snippet types, wherein said snippet relationships, snippet relationship orders and snippet types are all persisted and changeable in the Data Store;
within one Project, organizing snippets by ordered lists referred to as Sequence, which are persisted and changeable in the Data Store, either by user creation or by auto-generation based on properties of the snippets such as timestamps of creation or last edit, snippet relationships, snippet relationship orders or snippet types;
showing in user interface the user inputs of snippet,
wherein the user inputs of the shown snippet can be changed and updated in Data Store, and
the shown snippet's type can also be changed and updated in Data Store;
showing in user interface a graphical rendering of Project inside a virtual canvas contained in the UI instance referred to as Graphical View that makes clear the existence of snippets, snippet relationships, snippet relationship orders and snippet types, as well as the user-created Sequences and how they connect snippets,
wherein each graphical element representing a snippet has its appearance settings, and its location within the frame of said virtual canvas, changeable and persisted in the Data Store,
said virtual canvas can be zoomed in and out to view the graphical rendering of the Project in various levels of details, and
the graphical elements representing snippets and Sequences can be manipulated in the Graphical View to change the snippet relationships, their orders and the user-created Sequences;
showing in user interface a rendering of Sequence contained in the UI instance referred to as Text Stream View where the textual user inputs stored in the snippets of the Sequence are shown consecutively, in the order of the Sequence,
wherein any Sequence of a Project can be shown in the Text Stream View, and it is possible to switch between different Sequences of a Project to be shown in Text Stream View without leaving the Text Stream View.

12. The computer-implemented method of claim 11,
further comprising:
showing a type of user-implementable UI element referred to as “Switch” that overlays with a portion of the background text, wherein the overlaying element can display several versions for the overlaid text.

13. The computer-implemented method of claim 11,
further comprising:
storing multimedia inputs by the user into units of predefined data structures referred to as Profiles in Data Store whether on a general computer device or an external storage unit, wherein the user can link such profiles from other text displays within the APP.

14. The computer-implemented method of claim 13,
further comprising:
showing a type of user-implementable UI element referred to as “Switch” that overlays with a portion of the background text, wherein the overlaying element can display several versions for the overlaid text.

15. The system of claim 8,
further comprising:
migrating snippets into different Projects by user operation directly from UI and updating such changes in Data Store.

16. The computer-implemented method of claim 15,
further comprising:
migrating snippets into specially designed groups referred to as Recycle Bins,
and showing a specially designed UI View that displays such groups to the user wherein users can freely move snippets in and out of the Recycle Bins.

17. The computer-implemented method of claim 16,
further comprising:
showing a type of user-implementable UI element referred to as “Switch” that overlays with a portion of the background text, wherein the overlaying element can display several versions for the overlaid text.

18. The computer-implemented method of claim 15,
further comprising:
storing multimedia inputs by the user into units of predefined data structures referred to as Profiles in Data Store whether on a general computer device or an external storage unit, wherein the user can link such profiles from other text displays within the APP.

19. The computer-implemented method of claim 18,
further comprising:
showing a type of user-implementable UI element referred to as “Switch” that overlays with a portion of the background text, wherein the overlaying element can display several versions for the overlaid text.

20. The computer-implemented method of claim 19,
further comprising:
migrating snippets into specially designed groups referred to as Recycle Bins,
and showing a specially designed UI View that displays such groups to the user wherein users can freely move snippets in and out of the Recycle Bins; and
and a habit forming system that reward users for continuously updating their inputed contents by adding graphic elements to decorate the background of Views.
